(19) United States
(12) Patent Application Publication
(10) Pub. No.: US 2011/0229814 A1
(43) Pub. Date: Sep. 22, 2011

(54) TONER, METHOD OF MANUFACTURING TONER, AND IMAGE FORMING METHOD USING TONER

(76) Inventors: Masayuki KAKIMOTO, Shizuoka (JP); Akio MATSUI, Shizuoka (JP); Yoshikatsu MATSUDA, Shizuoka (JP); Masanori RIMOTO, Shizuoka (JP)

(21) Appl. No.: 13/046,134

(22) Filed: Mar. 11, 2011

(30) Foreign Application Priority Data
Mar. 17, 2010 (JP) 2010-061711
Mar. 17, 2010 (JP) 2010-061713
Jul. 28, 2010 (JP) 2010-169224
Jul. 28, 2010 (JP) 2010-169355

(51) Int. Cl. G03G 9/08; G03G 9/087; G03G 13/20

(52) U.S. Cl. 430/108.3; 430/105; 430/108.6; 430/109.4; 430/137.2; 430/124.1

(57) ABSTRACT

A toner containing a mother toner particle containing a binder resin, a releasing agent, and a coloring agent and an external additive comprising an inorganic particulate, which is mixed with the mother toner particle in a mixing process by a mixer, wherein the external additive is isolated from the mother toner particle by ultrasonic vibration and collected, in an aqueous solution comprising a polyoxyethylene lauryl ether compound serving as a surface active agent, in an amount of from 0.1 ppm to 10 ppm/(toner 4 g/100 ml) as measured by atomic absorption spectrometry.

### BACKGROUND OF THE INVENTION

1. Field of the Invention

The present invention relates to a toner, a method of manufacturing toner, and an image forming method using toner.

2. Description of the Background Art

Development agents for use in electrophotography, electrostatic recording, electrostatic printing, etc., and which include a development process, are temporarily attached to an image bearing member, or the like on which, for example, an electrostatic image is formed in the development process.

Next, the attached image is transferred in a transfer process from the image bearing member to a recording medium such as transfer paper directly or by way of an intermediate transfer medium and then fixed onto the recording medium in a fixing process.

Such development agents that develop electrostatic images formed on the surface of the image bearing member are classified into two types: a two-component development agent containing a carrier and a toner and a single-component development agent that does not require a carrier.

In a system using a two-component development agent, the toner attaches to the carrier, thereby degrading the development agent. In addition, such a system using a two-component development agent inevitably has a relatively large size in order to be able to replenish the toner to maintain a constant density of the toner to the carrier, which otherwise naturally decreases as the toner is consumed during image formation.

By contrast, the size of a system using a single-component development agent has shrunk due to usage of improved high-performance development rollers, etc.

In recent years, with advances in automation and colorization in business offices, there are greater opportunities to print graphics created by home computer, images taken by digital camera, and pictorial documents read by a scanner, etc., in a large amount, in addition to photocopying documents having only text, as, for example, presentation materials. Consequently, processing ability to deal with a single page having a complex arrangement formed of a solid image, a line image, a half toner image, etc., is also required, along with demand for higher reliability for imaging. This ability in turn depends heavily on the toner used for imaging.

The electrophotographic process using a single-component development agent is classified into a magnetic single component development system using magnetic toner and a non-magnetic single-component development system using non-magnetic toner. In the magnetic single component development system, a magnetic field generation device such as a magnet is provided in the development agent bearing member which bears a magnetic toner containing magnetic material such as magnetite. The thickness of the magnetic toner on the development agent bearing member is regulated (reduced) by a layer thickness regulator. In particular, small-sized printers employing this system have been popularly commercialized in recent years. However, most of the magnetic substances are black or close thereto, which is a disadvantage for colorization.

By contrast, in the non-magnetic single-component development system, toner is supplied to a development agent bearing member by a toner supply roller, etc. pressed against the development agent bearing member and held thereon by the force of electrostatic attraction, followed by layer thickness regulation by a layer thickness regulator before development. This system is advantageous in regard to colorization because no colored magnetic substance is contained therein. Moreover, no magnet is used in the development agent bearing member, which leads to further cost reduction and mass reduction. Therefore, this system is widely used in small-sized full color printers.

In the two-component development system, the carrier is used to charge and transfer the toner. After the toner and the carrier are sufficiently stirred and mixed in a development device, the mixture is transferred to the development agent bearing member for development. Therefore, the chargeability and the transfer property of the toner tend to be stably sustained for an extended period of use. This system is also advantageous in terms of high-speed performance.

In the non-magnetic single component development system, toner (development agent) is typically transferred by at least one toner transfer member. The transferred toner develops a latent electrostatic image formed on the latent image bearing member and the toner layer thickness on the surface of the toner transfer member is required to be extremely thin.

This is true in the case of the two-component development agent using a carrier having an extremely small particle diameter. In addition, when a single-component development agent having a toner having a high electric resistance is used, the toner is required to be charged by a development device so that the layer thickness of the toner is required to be extremely thin.

In short, if the layer thickness of the toner is thick, it is difficult to uniformly charge the entire toner layer, and only the toner located close to the surface is charged.

A quick charging speed and a suitable amount of charge are required of the toner. Therefore, charge control agents and external additives are typically added to stabilize charging for toner. The charge control agent controls the triboelectric amount of toner and maintains the amount.

Specific examples of negative charge control agents include, but are not limited to, monoazo dyes, metal salts or metal complex salt of salicylic acid, naphthoic acid, or dicarboxylic acid, and complex compounds of diazo compound, boron. In addition, specific examples of positive charge control agents include, but are not limited to, quaternary ammonium salts, imidazole compounds, nigrosine, and azine-based dyes.

However, some of these charge control agents have colors and thus are not suitable for color toner. In addition, some of these charge control agents have poor compatibility with a binder resin. Thus, the charge control agent present on the surface of the toner which particularly has a large impact on charging of the toner is easily detached. This causes problems such as non-uniform charging of the toner, contamination of a development sleeve, and filming of the image bearing member. As a result, the quality of produced images is good in the initial stage but background fouling occurs over time, thereby leading to deterioration of the image quality, production of rough-feel images, etc.

In particular, when the toner is continuously used in color photocopy while supplying the toner, the charge on the toner decreases, resulting in production of images having significantly different color tones from the images produced initially. Therefore, such a toner is not suitable for an extended period of use, and an image forming unit, referred to as a process cartridge, is required to be replaced at an early stage. This is a burden on the environment and inconvenient for the user. Furthermore, most process cartridges contain heavy metals such as chrome, which poses a safety problem.

Demand for printers has been strong in recent years, with demand for higher reliability and a longer working life of the apparatus rising with advances in size reduction, high-speed printing, and cost reduction. Toner is also required to sustain its characteristics over an extended period of time. However, such a charge control agent does not maintain the charge control effect but contaminates a development sleeve and a layer thickness regulator (blade or roller), degrades the charging ability of the toner, and causes filming of the image bearing member.

In addition, the development process is conducted in a short time with less development agent due to advances in the size reduction and high speed performance. Therefore, a development agent that can be charged with a steep rise is required.

With regard to development, various kinds of development systems for both single-component development agents and two-component development agents have been proposed so far. Among these, the non-magnetic single-component development system is preferable for printer use because it can be reduced in size and mass and dispense with a carrier.

The non-magnetic single-component development system is inferior with regard to supply of toner to a development roller and a holding toner property thereof. Therefore, the toner is forcibly rubbed against the development roller or the amount of the toner on the development roller is regulated by a blade.

As a result, the toner easily forms a film on the development roller, resulting in a short working life thereof and destabilizing the toner charge, which leads to bad development.

Therefore, external additives have been studied that serve to improve the transfer property, development property, transfer property, preservability, etc., of the toner, in addition to control and maintenance of the triboelectric amount of toner. For example, hydrophobic silica is added to toner in an attempt to improve these characteristics. However, the chargeability of toner excessively increases when silica is singly used and the transferability is excessively good, causing scattering of dust, etc.

Japanese patent application publication no. 2006-154387 (hereinafter referred to as JP-2006-154387-A) describes a combinational use of silica having a large particle diameter. However, the contamination of the charging roller is mainly caused by scattering of external additives from the image bearing member, and thus how to impart balanced force of attachment to a silica having a large particle diameter is an issue.

Japanese patent no. (hereinafter referred to as JP-2921174-B) describes manufacturing a toner having a high triboelectric property and a suitable fluidity free from bad transfer and image deficiency by keeping a shearing ratio, calculated by the front point speed of the blade in a mixer and a clearance from the wall of the mixer and the mixing time of the external additive, within a predetermined range.

JP-2003-255608-A describes a toner manufacturing method in which agglomerated materials of external additives are pulverized and the pulverized external additives are securely attached to or embedded in mother toner particles by keeping the average height of a mixture of the mother toner particles and external additives placed in a mixer from the base of the mixer to the surface of the powder mixture, the diameter of the mixer blade, the number of rotation thereof, and the mixing time all within predetermined ranges.

Moreover, JP-2000-267354-A describes a toner manufactured by a method in which the external addition temperature at the time of mixing toner particles and inorganic particulates is kept within a predetermined range relative to the glass transition temperature of the toner particles to securely embed the inorganic particulates into the toner particles, so that the toner reduces image deficiencies such as decrease of printing density even after continuous printing.

Furthermore, JP-3417213-B describes a method of manufacturing toner in which an external additive (=hydrophobic metal oxide) other than titanium oxide is admixed and then titanium oxide is admixed to improve the fluidity of the toner.

In addition, JP-2000-267354-A describes a method of manufacturing toner in which the amount of charge of the toner ten minutes after mixing is regulated under prescribed mixing conditions for the diameter and the inside dimension of the blade of a Henschel mixer, the number of rotations of the blade, and the mixing time, to obtain a toner in which the external additive is uniformly attached, thereby achieving stable chargeability. However, there is no mention of verification results about the attachment ratio and the isolation ratio of the external additive, so that the effect may be ascribable to the isolated additives.

In addition, JP-2006-323368-A describes a technology of adjusting attachment strength of an external additive by evaluation of the isolation ratio of the external additive and regulating the isolation ratio of titanium oxide for a toner having less carrier spent for an extended period of use while toner spent caused by stirring in a development unit drops in the unit and causes background fouling and contamination therein, against the trend of high-speed performance of printers. However, in this technology, there is a problem with the test method and the manufacturing method is not sufficiently described, particularly about the mixing process. Furthermore, there is no specific mention of the surface treatment for an external additive. Therefore, the issue is not solved by the combination described in this method.

In addition, JP-3129074-B and JP-2006-323368-A describe analysis of the attachment ratio of an external additive. Furthermore, with regard to the test method of an external additive, in JP-2006-154387-A and JP-2006-323368-A, the isolated external additives are abandoned, so that no analysis is done on the actual isolation ratio. That is, the agglomerated additive having a size of about 1 μm is separated by filter paper and calculated as the attached component. Therefore, the value obtained by the method in which the attachment ratio is calculated from fluorescent X ray analysis followed by subtraction from the content of the entire external additive is not dealt with as the isolated portion. Therefore, the isolation ratio of obtained by such a method is not accurate, and does not constitute a quantitative analysis.

Furthermore, JP-2006-058502-A describes a method of manufacturing toner in which an oil phase formed by dispersing/dissolving a binder resin and a pigment in, for example, an organic solvent and an aqueous phase formed of resin particulates, a water-miscible solvent, etc., are emulsified in a pipeline homomixer followed by removal of the solvent, washing, and drying. In this method, toner having a volume average particle diameter Dv of powder of the toner of from 4 to 8 μm, a ratio (Dv/Dn) of the volume average particle diameter Dv to the number average particle diameter Dn of the toner of from 1.00 to 1.25, and a content ratio of fine powder of the toner having a volume average particle diameter of 3 μm or less of 10% or less is obtained so that a toner having a small particle diameter with a narrow particle size distribution is proposed.

The toner manufactured by this method belongs to the chemical toner field. Therefore, the manufacturing cost of toner increases and since the content of the powder having a volume average particle diameter of 3 μm or less is limited to 10% or less, the yield ratio decreases, thereby further increasing the cost.

Various kinds of external additives are used as an indispensable toner composition to respond to the request for improving the speed of performance, image quality, and durability. In such a situation, as the size of the toner decreases, the size of the external additives is required to decrease accordingly. Attachment of such an external additive having a small particle diameter to the surface of small toner particles uniformly is beyond typical mixing methods and technologies.

That is, such typical mixing methods and technologies do not satisfy respective attachment requirements demanded by such various kinds of external additives.

Furthermore, JP-2008-70577 describes a toner manufactured by mixing external additives such as hydrophobic silica, titanium oxide, and zirconium oxide with a particular polyester resin using a mixer having a mixing blade set to rotate at a speed of from 3 to 10 m/s in the first mixing process and from 20 to 60 m/s in the second mixing process.

In this method, the first additive is hydrophobic silica having a BET specific surface area of from 80 to 200 m2/g and the second additive has a smaller BET specific surface area than the first additive. The toner has a number average particle diameter Dn of from 2.5 μm to 4.5 μm and a particle size distribution index (Dv/Dn) of from 1.0 to 1.3. The mother toner particles and 50% to 100% by weight of the total mass of the second additive are admixed first in the first mixing process followed by the second mixing process in which the rest of the second additive and the all of the first additive are admixed. However, mixing an additive having a large particle diameter with an additive having a small particle diameter is a known technology and there is no mention of the verification of the effect of the isolated component. Therefore, if silica having a large particle diameter which is not easily attached to the surface of mother toner particles is mixed in the first mixing process, the silica may be detached by a mechanical shearing force in the second mixing process.

Furthermore, JP-2007-86348 describes a method of manufacturing toner which includes a step of removing isolated external additive from toner particles having a small particle diameter manufactured by an emulsification polymerization agglomeration method without having an adverse impact on the toner performance with a cyclone device. There is also a mention of the ratio of isolated inorganic particulates and a method of evaluating and verifying the collection ratio of the isolated inorganic particulates by using a polyoxyethylene (10) octylphenyl ether based compound as a surface active agent.

This surface active agent does not have good hydrophilic properties (attachment wetting), which necessitates a high attachment density. This leads to disadvantages with regard to air bubbles and the use amount.

The present inventors have studied and researched the relationship between the intensity of the mixing energy and the strength of the attachment of the external additive in various kinds of mixing methods and found the following patterns.

In the case of using a blender such as a V type blender to conduct mixing with a relatively low energy, there is a peak in a portion area having a weak attraction force of attachment for the mixing energy. Therefore the mixing dispersion force is weak and thus the external additive is not dispersed but appears as a block.

In the case of using a mixer such as a Henschel mixer having a relatively middle range energy, there is a peak of the attachment ratio in the middle against the mixing energy with gentle tapering on both sides of weak force of attachment.

In a mixer whose force of attachment relatively depends on the number of rotation of wings or a high energy blender such as Mecanofusion that provides strong force of attachment with a high mixing energy, there are peaks and areas that partially have relatively weak force of attachment, which makes it difficult to uniformly attach external additives to toner.

In addition, as a method of securing the stability of the charging of toner, JP-H05-66608-A, JP-H04-9860-A, etc. describe addition of hydrophobized inorganic fine powder or hydrophobized inorganic fine powder which is further treated with silicone oil, etc. JP-S61-249059-A, JP-H04-264453-A, and JP-H05-346682 describe a method of using hydrophobized inorganic fine powder in combination with a silicone oil-treated inorganic fine powder.

JP-3230046-B describes a combinational use of toner particles having a small particle diameter with a specific external additive. JP-3639714-B describes a method in which the distribution of toner having a small particle diameter of 2 μm or less is regulated to stabilize the chargeability of toner particles, thereby improving the balance among text sharpness, solid black density, and omission with text. However, since the attachment state of the external additive over an extended period of time is not sustained particularly well in a system using recycled toner, the durability quality of the toner is not improved.

In addition, JP-3216394-B describes a method of uniformly attaching an external additive to mother toner particles by mixing only the mother toner particles first to obtain pulverized primary particles followed by attaching a predetermined external additive to the surface of the primary mother toner particles in the mixing process.

However, since this is a mixing method in which mixing of the external additive starts from placing it on one part of the pulverized primary mother toner particles, the external additive is not uniformly attached so that the stability of the chargeability is not improved.

JP-2008-70577-A describes a method of mixing one of the two kinds of external additives with mother toner particles followed by mixing with the other of the two, to limit isolation of the external additives. However, the second external additive is not sufficiently dispersed.

### SUMMARY OF THE INVENTION

For these reasons, the present inventors recognize that a need exists for a toner that produces quality images by controlled triboelectric charging amount of toner and stably maintained triboelectric charging property in environment change, thereby preventing production of abnormal images caused by attachment of the toner and toner component such as an external additive to an image bearing member during development of toner images by employing a particular mixing system in which an external additive is strongly attached to the mother toner particles having a regulated particle size distribution and a method of manufacturing the toner and an image forming method using the toner.

Accordingly, an object of the present invention is to provide a toner that produces quality images by controlled triboelectric charging amount of toner and stably maintained triboelectric charging property in environment change, thereby preventing production of abnormal images caused by attachment of the toner and toner component such as an external additive to an image bearing member during development of toner images by employing a particular mixing system in which an external additive is strongly attached to the mother toner particles having a regulated particle size distribution and a method of manufacturing the toner and an image forming method using the toner.

Briefly this object and other objects of the present invention as hereinafter described will become more readily apparent and can be attained, either individually or in combination thereof, by a toner containing a mother toner particle containing a binder resin, a releasing agent, and a coloring agent and an external additive containing an inorganic particulate. The external additive is mixed with the mother toner particle in a mixing process by a mixer. The external additive is isolated from the mother toner particle by ultrasonic vibration and collected, in an aqueous solution containing a polyoxyethylene lauryl ether compound serving as a surface active agent, in an amount of from 0.1 ppm to 10 ppm/(toner 4 g/100 ml) as measured by atomic absorption spectrometry.

It is preferred that, in the toner mentioned above, the mixing process includes one or more cycles including operation time and cooling-down time in a ratio of from 0.5 to 5.0 of the operation time to the cooling-down time.

It is still further preferred that, in the toner mentioned above, one cycle of operation time and cooling-down time is from one minute to two minutes.

It is still further preferred that, in the toner mentioned above, the mixing process includes dispersing the inorganic particulate in the mother toner particle and attaching the inorganic particulate to the mother toner particle.

It is still further preferred that, in the toner mentioned above, the inorganic particulates contains silica and the isolated amount of silica from the mother toner particle as measured by atomic absorption spectrometry is from 0.1 ppm to 10 ppm/(toner 4 g/100 ml).

It is still further preferred that, in the toner mentioned above, wherein the silica has a specific surface area of from 150 m2/g to 250 m2/g.

It is still further preferred that, in the toner mentioned above, the inorganic particulate contains titanium oxide and the amount of titanium in the isolated titanium oxide from the mother toner particle measured by atomic absorption spectrometry is from 0.1 ppm to 5 ppm/(toner 4 g/100 ml).

It is still further preferred that, in the toner mentioned above, the silica is attached to a surface of the mother toner particle together with or prior to the titanium oxide.

It is still further preferred that, in the toner mentioned above, the mother toner particle has a volume average particle diameter Dv of from 4.5 to 5.2 μm, a content ratio of particles having a particle diameter of 4.0 μm or less of 60% or less by quantity, and a ratio (Dv/Dn) of the volume average particle diameter Dv to a number average particle diameter Dn of from 1.10 to 1.40.

It is still further preferred that, in the toner mentioned above, the mother toner particle has a content ratio of particles having a particle diameter of 3.2 μm or less of 35% or less by quantity and a volume content ratio of particles having a particle diameter of 8 μm or greater of 2.0% or less.

It is still further preferred that, in the toner mentioned above, a content of the releasing agent in the mother toner particle is less than 6% by weight.

It is still further preferred that the toner mentioned above further contains a charge control agent.

It is still further preferred that, in the toner mentioned above, the binder resin contains a polyester resin.

As another aspect of the present invention, a method of manufacturing toner is provided which includes pulverizing a toner material containing a binder resin, a releasing agent, and a coloring agent, then air-classifying the pulverized toner material to obtain mother toner particle and mixing an inorganic particulate with the mother toner particle with a mixer which includes a step of dispersing the inorganic particulate in the mother toner particle and a step of attaching the inorganic particulate to the mother toner particle, wherein the toner is subjected to ultrasonic vibration to collect isolated external additive in an aqueous solution containing a polyoxyethylene lauryl ether compound serving as a surface active agent and the amount of the isolated external additive measured by atomic absorption spectrometry is from 0.1 ppm to 10 ppm/(toner 4 g/100 ml).

It is preferred that, in the method of manufacturing toner, the step of mixing includes an operation time and a cooling-down time with a ratio of the operation time to the cooling-down time mixing time of from 0.5 to 5.0.

It is still further preferred that, in the method of manufacturing toner, the mixer has a stirring blade and one cycle of the operation time and the cooling-down time is from one minute to two minute.

As another aspect of the present invention, a method of manufacturing toner is provided which includes the steps of pulverizing a toner material containing a binder resin, a releasing agent, and a coloring agent to obtain pulverized toner material, air-classifying the pulverized toner material to obtain a mother toner particle, and mixing an external additive containing an inorganic particulate with the mother toner particle using a mixer, which includes the steps of dispersing the inorganic particulate to the mother toner particle and attaching the inorganic particulate to the mother toner particle, wherein the external additive is isolated from the mother toner particle by ultrasonic vibration and collected, in an aqueous solution containing a polyoxyethylene lauryl ether compound serving as a surface active agent, in an amount of from 0.1 ppm to 10 ppm/(toner 4 g/100 ml) as measured by atomic absorption spectrometry.

It is preferable that, in the method of manufacturing toner mentioned above, the step of mixing includes an operation time and a cooling-down time with a ratio of the operation time to the cooling-down time mixing time of from 0.5 to 5.0.

It is still further preferred that, in the method of manufacturing toner mentioned above, the mixer has a stirring blade and one cycle of the operation time and the cooling-down time is from one minute to two minute.

As another aspect of the present invention, an image forming method is provided which includes forming a latent electrostatic image on an image bearing member, developing the latent electrostatic image with the toner mentioned above to obtain a toner image, transferring the toner image to a recording medium, and fixing the toner image on the recording medium.

### BRIEF DESCRIPTION OF THE DRAWINGS

Various other objects, features and attendant advantages of the present invention will be more fully appreciated as the same becomes better understood from the detailed description when considered in connection with the accompanying drawing(s) in which like reference characters designate like corresponding parts throughout and wherein:

FIG. 1 is a schematic diagram illustrating an example of the process cartridge of the present disclosure; and

FIGS. 2A, 2B, 2C and 2D are SEM photographs illustrating examples of the external additive attached to the toner manufactured by the method of manufacturing toner of the present disclosure.

### DETAILED DESCRIPTION OF THE PRESENT DISCLOSURE

As a result of inventive studies made by the present inventors, it is found that toner particles having a weak force of attachment are produced for the mixing energy in a typical manufacturing condition, resulting in non-uniformity among toner particles with regard to the force of attachment. These toner particles having a weak force of attachment cause separation of external additives therefrom, which leads to problems about the shearing force during stirring with carrier particles and abrasion with the image bearing member at the development unit. Therefore, the present inventors adjust the particle size distribution of classified toner by reducing the content ratio of fine toner particle having a particle diameter of 3.2 μm or less and removing coarse toner particles having a particle diameter of 8.0 μm or greater as much as possible to control the attachment state of the external additive including inorganic particulates such as silica to the toner. According to this, the present inventors have found that a mixing method imparting a middle-range (=lower) energy is optimal. That is, in such a mixing method, the force of attachment of the external additive to the toner is controlled to be uniform by reducing the toner particles having a weak force of attachment to the least as much as possible

In a further intensive study, usage of a Henschel mixer has been researched to impart a constant energy to toner. As a result of analysis about swirling state of the air in the mixing tank as a mixing blender considering the cooling-down cycle of the tip of the rotary blade based on the conditions of the volume and the rotation energy, the force of attachment of the external additive to the toner can be uniform by controlling the rotation and efficiently imparting the energy according to the objective to the toner.

The toner of the present disclosure stably controls and maintains the amount of triboelectric charging and a triboelectric charging property without being affected by the environment change and produces no abnormal images related to filming caused by attachment of an external additive such as silica to an image bearing member that occurs during development of images with the toner by extremely limiting the amount of isolated components of the external additive. The method of manufacturing the toner is also provided.

The toner is manufactured by pulverizing a toner material containing a binder resin, a releasing agent, a coloring agent, etc. to obtain mother toner particles and mixing the mother toner particles with an external additive such as inorganic particulates by a mixer followed by air-classification. The toner is subjected to ultrasonic vibration to isolate the external additive and the isolated external additive is collected in an aqueous solution containing a surface active agent of a polyoxyethylene lauryl ether. The amount of the collected external additive measured by atomic absorption spectrometry is from 0.1 ppm to 10 ppm/(toner 4 g/100 ml). Therefore, the toner has improved chargeability and in particular improved environment stability, enabling quality images free from filming to be continuously produced for an extended period of time in environments ranging from high temperature and high humidity to low temperature and low humidity.

In addition, the toner is manufactured by conducting a cycle of mixing (operating) time and cooling-down time repeatedly in the mixing process with a ratio of the mixing time to the cooling-down time of from 0.5 to 5.0. Therefore, the temperature does not rise during mixing so that the chargeability, for example, the fluctuation in the amount of charge of the toner from a low temperature low humidity environment to a high temperature humidity environment, is very small and no abnormal images caused by filming but quality images are stably and continuously printed for an extended period of time.

The amount of isolated external additive such as silica toner from the mother toner particle measured by an atomic absorption spectrometry is from 0.1 ppm to 10 ppm (toner 4 g/100 ml). In addition, the surface active agent that is used to separate the attached component and the isolated component in the ultrasonic vibration operation has a function of dissolving hydrophobic particulates. Therefore, the isolated component can be quantified from the aqueous component in which the isolated component is dissolved so that the quantification accuracy is extremely improved. Consequently, the mechanical stirring energy, the rotation blade, the attachment state of the external additive, and the variation of the isolated component can be exactly analyzed to obtain a target toner with ease.

In addition, titanium oxide is preferably attached to the mother toner particles as an external additive. The amount of isolated titanium from the mother toner particles measured by an atomic absorption spectrometry is from 0.1 ppm to 5 ppm (toner 4 g/100 ml). In this range, the chargeability does not significantly change. For example, the variation of the amount of charge is small in environments ranging from high temperature and high humidity to low temperature and low humidity. Consequently, no abnormal images caused by filming but quality images are stably and continuously printed for an extended period of time.

Furthermore, the isolated amount of an external additive can be obtained by a plasma spectral analysis (ICP□AES) method but a method in which the isolated amount is directly obtained is not described.

JP-2006-154387-A and 2006-323368-A obtain the isolated amount by analyzing the attachment ratio by fluorescent X ray and subtracting it from the total amount. This method requires the total amount of the external additive.

To the contrary, in the present disclosure, the isolated amount of the external additive is exactly analyzed based on the external additive attached to the toner. That is, the isolated amount is quantified by directly analyzing the filtered liquid.

Therefore, analytic studies about the force of attachment of the external additive, the mixing treatment, etc. can be conducted and thus the precision of the analysis is improved.

Moreover, the mixing device for use in mixing the mother toner particle with the external additive in the mixing process is a mixer having a stirring blade such as a Henschel mixer.

The mixing time in the one cycle is from one to two minutes, which is the mixing condition to adjust the isolation ratio of external additive such as silica to be from 0.1 ppm to 10 ppm.

The thus manufactured toner has suitable chargeability and hardly scatters, thereby not causing background fouling.

Furthermore, agglomeration of external additive particles of silica, titanium oxide, etc. can be reduced and the external additives can be uniformly attached to mother toner particles by adjusting to have specific toner having a volume average particle diameter Dv of from 4.5 μm to 5.2 μm, a content ratio of toner particles having a particle diameter of 4.0 μm or less of 60% or less based on the number of toner particles, a ratio Dv/Dn of the volume average particle diameter Dv to the number average particle diameter Dn of from 1.10 to 1.40. Therefore, the obtained toner is good about the chargeability such as the charge rising and the amount of charge, thereby preventing scattering of toner and occurring of background fouling. In addition, by limiting the content ratio of fine toner particles having a particle diameter of 3.2 μm or less to be 35% or less based on the number of toner particles and coarse toner particles having a particle diameter of 8.0 μm or greater to be 2.0% or less based on volume of toner particles, the shearing force is uniformly applied to the fine toner particles in the mixing tank so that the external additive is uniformly attached to the mother toner particle and the coarse toner particles are classified and removed so that the particle size distribution becomes narrow and thus the stirring force is uniformly applied during mixing. The obtained toner is good about the chargeability such as the initial charge rising and the amount of charge, thereby preventing scattering of toner and occurring of background fouling. Moreover, the external additive is uniformly attached and agglomeration of toner powder is reduced so that the fluidity of the toner is improved when the content of the releasing agent inside the toner particle is 6% or less.

In addition, by a combinational use with titanium oxide, the initial charge rising becomes stable and the triboelectric amount of charge of the toner is stably controlled and maintained. In addition, the stability for the environment change also becomes good. Furthermore, the obtained toner is good about the transfer property, the development property, the preservability, etc. without causing production of abnormal images due to attachment to the image bearing member.

With regard to the toner of the present disclosure, the attachment ratio of the external additive is uniform and the isolation ratio of titanium oxide from the mother toner particle by using ultrasonic vibration method is from 0.1 ppm to 5 ppm. Therefore, the chargeability of the toner particle is improved and in particular the environment stability, enabling quality images free from fogging to be continuously produced for an extended period of time in environments ranging from high temperature and high humidity to low temperature and low humidity.

In particular, when a surface reforming treatment agent having a negative polar group is used in combination, the durability and the environment stability can be furthermore improved, thereby reducing the cost.

Furthermore, as the surface active agent, a polyoxyethylene lauryl ether compound having a HLB of from 12 to 18 is used and the concentration of the aqueous solution is adjusted to be from 0.01 to 0.5% by weight. This is suitable to collect silica isolated by the ultrasonic vibration method and quantify the isolated component for analysis.

In addition, the toner of the present disclosure is suitably used in an image forming method which includes a charging process of applying a voltage to a charging member from outside, a latent electrostatic image forming process of forming a latent electrostatic image on an image bearing member, a development process of forming a toner image from the latent electrostatic image by a development device such as a development sleeve, a transfer process of transferring the toner image to a recording medium by applying a voltage to a transfer member from outside, a cleaning process to clean the surface of the charge image bearing member after transfer with a cleaning member, a fixing process of fixing the transferred image on the recording medium upon application of heat and pressure, and other suitably selected optional processes.

### Toner and Method of Manufacturing Toner

The toner manufactured by the method of manufacturing toner of the present disclosure is formed of the mother toner particle having at least a binder resin and a coloring agent with a specific particle size distribution and an external additive such as silica and titanium oxide attached to the mother toner particle. The toner is subjected to ultrasonic vibration to collect isolated external additive in an aqueous solution containing a polyoxyethylene lauryl ether compound serving as a surface active agent, and an amount of the isolated external additive measured by atomic absorption spectrometry is from 0.1 ppm to 10 ppm/(toner 4 g/100 ml). The external additive is preferably mixed with the mother toner particle by repeating a cycle of mixing (operating) and cooling-down once to ten times. The ratio of the mixing time (operation time) to the cooling-down time in the mixing cycle is preferably from 0.5 to 5.0 and the isolation amount of the external additive from the mother toner particle by the ultrasonic vibration method is from 0.1 to 10 ppm.

It is also preferable that the external additive includes silica and the isolation amount of silica from the mother toner particle by the ultrasonic vibration method is from 0.1 to 10 ppm. More preferably, the external additive further includes titanium oxide and the isolation amount of titanium oxide from the mother toner particle by the ultrasonic vibration method is from 0.1 to 5 ppm.

The toner of the present disclosure is manufactured by the method of manufacturing toner of the present disclosure. The method of manufacturing toner of the present disclosure is described below and then the toner of the present disclosure is also described.

The method of manufacturing toner of the present disclosure is applicable to the method of manufacturing pulverized toner in which toner materials are pulverized to obtain coarse particles followed by further pulverization in an jet air and air-classification. The obtained mother toner particle preferably has a volume average particle diameter Dv of from 4.5 μm to 5.2 μm, a content ratio of toner particles having a particle diameter of 4.0 μm or less of 60% or less, a ratio Dv/Dn of the volume average particle diameter Dv to the number average particle diameter Dn of from 1.10 to 1.40. More preferably, the obtained mother toner particle has a content ratio of fine particles having a particle diameter of 3.2 μm or less to be 35% or less based on the number of toner particles and coarse particles having a particle diameter of 8.0 μm or greater to be 2.0% or less based on volume of toner particle.

In the mixing process, the mother toner particles and the external additive are placed in a mixer and mixed with a low energy and then a high energy to disperse the external additive in the entire of the mother toner particle in the low energy mixing and fix the external additive onto the entire of the mother toner particle in the high energy mixing. Therefore, the external additive is not detached from the mother toner particle so that the obtained toner has a long working life and quality images free from non-uniform image density, white streaks, etc. can be produced for an extended period of time by using the toner.

To be specific, it is preferable to use a conical rotor method because the torque is low.

As described above, the mixing process in the method of manufacturing toner of the present disclosure includes a “low energy mixing stage” and a “high energy mixing stage”. In the low energy mixing stage, mainly raw materials are pulverized to dissociate the association state thereof into dispersion with a low energy. In the high energy mixing stage, mainly inorganic particulates are attached to mother toner particles with a high energy.

“Mainly” represents that, although the inorganic particulates are initially pulverized and then attached to the mother toner particles, to be strict speaking, the external additive is still pulverized in the high energy mixing stage. However, the shearing power is greater in the high energy mixing.

Cooling-down in the mixing process is provided to control mixing time and cooling-down time. If the cooling-down time is relatively short in comparison with the mixing time or not provided, it is difficult to prevent the temperature rise during mixing. Therefore, in the present disclosure, the cooling-down process is provided and its ratio is determined.

The number of rotation is preferably set to be greater in the mixing than cooling-down. This can be adjusted by the time and the number of repeating cycles.

Preferable temperature, time, number of rotation during mixing/cooling-down for each of the low energy mixing stage and the high energy mixing stage are shown in Table 1.

TABLE 1

| | Mixing step of external additive | | | |
|---|---|---|---|---|
| | Dispersion stage (low- | | Attaching stage (high- | |
| Preferable | energy mixing) | | energy mixing) | |
| condition | Mixing | Cooling down | Mixing | Cooling down |
| Time (sec) | 30-60 | 10-30 | 60-120 | 30-60 |
| Temperature | 20-35 | 20-35 | 20-35 | 20-35 |
| (° C.) | | | | |
| Number of | 100-400 | 0 to less | 400-1500 | 0 to less |
| rotations | | than 400 | | than 400 |
| (rpm) | | | | |

| | | |
|---|---|---|
| Number of | 1 to 3 times | 5 to 10 times |
| cycles | | |

Specific examples of the mixers include, but are not limited to, V-type mixers, Rocking mixers, Lodige mixers, Nautor mixers, and Henschel mixers. The volume ratio of raw material is preferably from about 60% to about 80%.

To be specific, a super mixer of a typical Henschel mixer that can rotate at a high speed is used.

A mixture of the mother toner particle and the external additive is placed in the mixing room.

The rotation blade used is preferably a two stage type. The mixture of the mother toner particles and the external additives swirls while being pressed against the walls of the mixing room by the force of rotation and gathers at the tip of the rotation blade for mixing.

Thereafter, the mixture is detached once from the wall by a deflector, dispersed, and again pressed against the wall of the mixer for swirling and mixing.

This operation is repeated to stably mix the mixture.

The temperature in the jacket in the second mixing stage is controlled to be in the range of from 20° C. to 35° C. and the number of rotation of the stirring blade is preferably around 1,000 rpm. A number of rotation that is excessively high (e.g., 1,200 rpm) tends to cause generation of excessive friction heat accompanying danger.

The ratio between the mixing time and the cooling-down time in the mixing process is from 0.5 to 5.0 and preferably from 0.5 to 3.0.

If the cooling-down time is relatively short in comparison with the operation time (mixing time), a large amount of friction heat is generated, causing embedding of the external additive, which leads to degradation of toner fluidity and increase of production of agglomeration thereof.

It is preferable that the mixing time in one cycle in the mixing process is within 2 minutes.

External additives such as hydrophobized silica and hydrophobized siloxane-linked titanium oxide are mixed with a mother toner particles, and the cycle including mixing (operating) and cooling-down is repeated once to ten times during the mixing process.

When the repeating number of the cycles is too few, the force of attachment tends to be weak. Therefore, when used as a developer, isolated external additive easily causes a carrier-spent problem or has an adverse impact on the quality objective of the present disclosure.

In addition, an air stream source can be optionally provided on the lateral side of the mixer to improve the efficiency of mixing and dispersion of the powder layer swirling. The diameter of such an air stream source is about one third to the diameter of the rotation blade. That is, the rotation of the mixing blade at a high speed causes a swirl flow, which mixes at least two kinds of particles.

A suitable attachment strength is determined by the circumferential velocity of front edge and the number of rotations of the mixing blade.

There is no specific limit to the hydrophpobic silica and any known hydrophobic silica can be used. In terms of carrier spent and attachment efficiency to the mother toner particle, hydrophobic silica treated by a silane coupling agent is preferable and preferably has a hydophophobization degree of from 60 to 80 and more preferably of 70 to greater.

The inorganic particulate for use in the present disclosure is preferably at least one kind of silica having an average primary particle diameter of from 80 to 500 nm in terms of removing toner on the image bearing member after transfer.

Silica having such an average primary particle diameter tends to adhere to the image bearing member, thereby removing the toner thereon easily by dam effect.

Another preferable external additive is titanium oxide.

In addition, at least one of the inorganic particulates for use in the present disclosure is preferably a hydrophobic inorganic particulate treated by an organic silane compound. This is excellent to improve the environment stability and produce quality images with less image deficiency.

Using hydrophobic silica and hydrophobic titanium oxide in combination is also preferable.

Specific examples of the hydrophobizing agents include, but are not limited to, organic silane compounds such as dimethyldichlorosilane, trimethylchlorosilane, methyltrichlorosilane, aryldimethyldichlorosilane, benzyldimethylmethylchlorosilane, bromomethyl dimethylchlorosilane, α-chloroethyltrichlorosilane, p-chloroethyltrichlorosilane, chlolomethyldimethylchlorosilane, chloromethyltrichlorosilane, p-chlorophenyl trichlorosilane, 3-chloropropyl triethoxysilane, vinyltriethoxysilane, vinylmethoxysilane, vinyltris(β-methoxyethoxy)silane, γ-methacryloxy propyltrimethoxysilane, vinyltriacetoxy silane, divinyldichlorosilane, dimethylvinyl chlorosilane, octyltrichlorosilane, decyltrichlorosilane, nonyltrichlorosilane, (4-t-propylphenyl)trichlorosilane, (4-t-butylphenyl)trichlorosilane, dipentyldichlorosilane, dihexyldichlorosilane, dioctyldichlorosilane, dinonyldichlorosilane, didecyldichlorosilane, didodecyldichlorosilane, dihexadecyldichlorosilane, (4-t-butylphenyl)octyldichlorosilane, dioctyldichlorosilane, didecenyldichlorosilane, dinonenyldichlorosilane, di-2-ethylhexyl dichlorosilane, di-3,3-dimethylpentyldichlorosilane, trihexylchlorosilane, trioctylchlorosilane, tridecylchlorosilane, dioctylmethylchlorosilane, octyldimethylchlorosilane, (4-t-propylphenyl)diethylchlorosilane, isobutyltrimethoxysilane, methyltrimethoxysilane, octyltrimethoxysilane, trimethoxy(3,3,3-trifluoropropyl)silane, hexamethyldislazane, diethyltetrathyldislazane, hexaphenyldislazane, and hexatolyldislazane; modified silicone oils such as dimethylsilocone oil, methylphenyl silicone oil, chlorophenyl silicone oil, methylhydrogen silicone oil, alkyl modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, meracaptomodified silicone oil, acryl-modified silicone oil, methacryl-modified silicone oil, and a-methylstyrene-modified silicone oil; silylating agents; silane coupling agents having a fluorinated alkyl group; organic titanate-based coupling agents; and aluminum-based coupling agents. Among these, organic silane compounds are preferable.

The inorganic particulates are subjected to treatment by these hydrophobizing agents to manufacture the hydrophobic inorganic particulates for use in the present disclosure.

Specific examples of the marketed products of the hydrophobized silica particulates include, but are not limited to, HDK H 2050EP and HVK32 (manufactured by Hoechst AG), R972, R974. RX200, RY200, R202, R805, and R812 (manufactured by Nippon Aerosil Co., Ltd.), and TS530 and TS720 (manufactured by Cabot Corporation).

In addition, anatase type crystal or rutile type crystal and non-crystal type can be used. Specific examples of the marketed products of surface-treated titanium oxide particulates include, but are not limited to, T-805 (manufactured by Nippon Aerosil Co., Ltd.) and STT-30A and STT-30A-FS (rutile type, both manufactured by Titan Kogyo, Ltd.).

The particle diameter of the inorganic particulates for use in the present disclosure can be measured by a particle size distribution measuring device using dynamic light scattering, for example, DLS-700 (manufactured by Otsuka Electronics Co., Ltd.) and Coulter N4 (manufactured by Coulter Electronics Co., Ltd.).

However, since it is difficult to separatio secondary agglomeration of particles after the treatment by an organic silane compound, it is preferable that the particle diameter is directly obtained from photographs taken by a scanning electron microscope or a transmission electron microscope.

At least 100 inorganic particulates are observed to obtain the average of the major diameter.

The toner of the present disclosure preferably contains a releasing agent (wax) component and in particular carnauba wax.

Carauba wax is a natural wax obtained from leaves of Copenicia cerifera Mart. A low acid value type obtained by free fatty acid detachment is preferable because it can be uniformly dispersed in a binder resin.

In addition, carnauba wax of the low acid value type obtained by free fatty acid detachment has few volatile components so that filming on the image bearing member and spent on the charging members are less, which is preferable.

In the present disclosure, to improve the image quality, it is preferable that the volume average particle diameter of the toner is from 4.5 to 5.2 μm, the content ratio of toner particles having a small particle size (i.e., 4.0 μm or less) is not greater than 60% by quantity, and the ratio (Dv/Dn) of the volume average particle diameter Dv to the number average particle diameter Dn is from 1.00 to 1.50.

When the particle diameter is too small, the productivity of the toner tends to deterioratio extremely and the durability and the fluidity also easily deterioratio, which is not preferable.

When the volume content ratio of particles having a particle diameter of 8 μm or greater is greater than 2.0%, the image quality is not significantly improved.

Furthermore, when the ratio Dv/Dn is outside the range of from 1.00 to 1.50, the particle size distribution tends to be wide, resulting in deterioration of the image quality.

The volume average particle diameter, the number average particle diameter, and the number % of toner particles having a particle diameter of 4 μm or less are measured by Coulter Counter TAII (manufactured by

Coulter Electronics Co., Ltd.) that is connected with an interface (manufactured by the institute of Japanese Union of Science and Engineers) that outputs the number distribution and the volume distribution and PC 9801 home computer (manufactured by NEC Corporation). 1% NaCl aqueous solution using primary sodium chloride is prepared as the electrolyte.

The Measuring Method is as Follows:

Add 0.1 to 5 ml of a surface active agent (preferably alkyl benzene sulfonic acid salt) as a dispersant to 50 to 100 ml of the electrolyte followed by an addition of 1 to 10 mg of a sample; Subsequent to dispersion treatment by an ultrasonic dispersion device for one minute, place 100 ml to 200 ml of the electrolytic aqueous solution in another beaker; add the sample liquid dispersion thereto in such a manner to obtain a predetermined density; measure the particle size distribution of 30,000 particles having a particle diameter of from 2 μm to 40 μm by Coulter Counter TA-II with an aperture of 100 μm based on the number of particles; calculate the volume distribution and the number distribution of the particles of from 2 μm to 40 μm; and obtain a volume average particle diameter based on the mass from the volume distribution.

In the present disclosure, it is preferable that the content ratio based on the number of particles with regard to particles having a particle diameter of 3.2 μm is 35% or less for improvement of the image quality.

A content ratio of such fine powder that is too high tends to cause background fouling of the image bearing member and scattering of toner in the machine, which is not preferable.

In addition, when the volume content ratio of the toner particles having a particle diameter of 8 μm or greater is 2.0% or less, the image quality is expected to be improved.

The toner of the present disclosure can contain wax without causing filming and has an excellent transfer property, which is advantageous for improvement of the image quality. Therefore, the toner can be suitably used for a full color image forming apparatus.

In particular, in the two component development, which is suitable for improving the speed of the performance, the toner is suitable for a tandem type development method using an image bearing members for each color.

Furthermore, considering the excellent transfer property, the toner is suitable for a tandem type intermediate transfer system having multiple transfer processes.

In addition, since the performance of the toner is excellent in a low temperature fixing system, the preparation time is short. Therefore, the toner is suitably used in a energy-saving fixing device that can fix images with a low pressure at a high speed.

For example, a suitable fixing device has a heating body that heating element, a film in contact with the heating body, and a pressing member that pressed the hearing body via the film to fix images on a recording medium while the recording medium passes between the film and the pressing member or another suitable fixing device has a heating member formed of magnetic metal which generatios heat by electromagnetic induction.

In the present disclosure, as the external additive which is externally added to mother toner particles, typically used titanium oxide can be used in combination with silicon dioxide.

Hydrophobized products thereof are preferable and hydrophobized titanium oxide having a primary particle diameter of from 10 nm to 20 nm is particularly preferable.

By attaching such an external additive to the surface of the mother toner particle, fluidity is imparted to the toner, the chargeability of the toner is stabilized. Therefore, the development from the development roller to the image bearing member is improved.

A toner having a stable chargeability is obtained particularly when such an external additive is used in the toner containing a polyester resin as the binder resin.

In terms of maintenance of the quality in environmental change and during continuous use for an extended period of time, good performance of the external additive is indispensable to improvement of the abrasion durability against a carrier and reduction of the occurrence of toner spent and filming on the surface of the image bearing member.

### Development Agent

The development agent in the present disclosure contains the toner described above and other suitably selected components such as carriers.

The development agent can be a one-component development agent and a two-component development agent and the two-component development agent is preferable in terms of length of the working life particularly when used in a high speed printer that meets the demand for high speed information processing of late.

There is no specific limit to the selection of the carrier. A carrier is preferable which includes a core and a resin layer that covers the core.

There is no specific limit to the selection of the material for the core and any known material can be suitably used. For example, manganese-strontium (Mn—Sr) based materials and manganese-magnesium (Mn—Mg) based materials having 50 to 90 emu/g are preferable. To secure the image density, highly magnetized materials such as iron powder having 100 emu/g or more and magnetite having 75 to 125 emu/g are preferable.

In addition, weakly magnetized copper-zinc (Cu—Zn) based materials having 30 to 80 emu/g are preferable in terms of reducing the impact of the contact between the toner filaments formed on the development roller and the image bearing member, which is advantageous in improvement of the image quality.

These can be used alone or in combination.

The core preferably has a volume average particle diameter D50 of from 10 to 200 μm and more preferably from 40 to 100 μm.

When the volume average particle diameter D50 is too small, fine powder tends to increase in the distribution of the carrier particles and the magnetization per particle tends to decrease, which leads to scattering of the carrier particles. When the volume average particle diameter D50 is too large, the specific surface area tends to decrease, resulting in scattering of toner. In a full color image in which solid portions occupy a large ratio, reproducibility tends to deteriorate particularly in the solid portions.

There is no specific limit to the selection of the materials for the resin layer mentioned above and any known resin can be suitably used. Specific examples thereof include, but are not limited to, amino-based resins, polyvinyl-based resins, polystyrene-based resins, polycarbonate-based resins, polyethylene resins, polyvinyl fluoride resins, polyvinylidene fluoride resins, polytrifluoroethylene resins, polyhexafluoropropylene resins, copolymers of vinylidenefluoride and acrylate monomer, copolymers of vinylidenefluoride and vinylfluoride, fluoroterpolymers such as terpolymers of tetrafluoroethylene, fluorovinylidene, and monomer including no fluorine atom, and silicone resins.

These can be used alone or in combination.

Specific examples of the amino-based resins include, but are not limited to, urea-formaldehyde resins, melamine resins, benzoguanamine resins, urea resins, polyamide resins, and epoxy resins.

Specific examples of the polyvinyl-base resins include, but are not limited to, acrylic resins, polymethylmethacrylate resins, polyacrylonitrile resins, polyvinyl acetate resins, polyvinyl alcohol resins, and polyvinyl butyral resins.

Specific examples of the polystyrene resins include, but are not limited to, polystyrene resins and styrene-acrylic copolymers.

A specific example of the halogenated olefin resins includes, but are not limited to, polyvinly chloride. Specific examples of the polyester resins include, but are not limited to, polyethyleneterephthalate resins and polybutyleneterephthalate resins.

The resin layer may contain electroconductive powder such as metal powder, carbon black, titanium oxide, tin oxide, and zinc oxide.

The average particle diameter of such electroconductive powder is preferably not greater than 1 μm. When the average particle diameter is too large, controlling electric resistance may become difficult.

The resin layer described above can be formed by, for example, dissolving the silicone resin described above in a solvent to prepare a liquid application and applying the liquid to the surface of the core described above by a known application method followed by drying and baking.

Specific examples of the known application methods include, but are not limited to, a dip coating method, a spray coating method, and brushing method.

There is no specific limit to the selection of the solvent. Specific examples thereof include, but are not limited to, toluene, xylene, methylethylketone, methylisobutyll ketone, and cellosolve butylacetate.

There is no specific limit to the baking. An external heating system or an internal heating system can be used. For example, a fixed electric furnace, a fluid electric furnace, a rotary electric furnace, a method of using a burner furnace, and a method of using a microwave can be suitably used.

The content of the carrier in the resin layer is preferably from 0.01 to 5.0% by weight.

When the content is too small, a uniform resin layer is not formed on the surface of the core with ease.

When the content is too large, the resin layer tends to be thick, causing granulation of carrier particles, meaning that uniform carrier particles are not obtained.

When the development agent is the two component development agent, there is no specific limit to the content of the carrier in the two component development agent. For example, the content is preferably from 90 to 98% by weight and more preferably from 93 to 97% by weight.

The mixing ratio of the toner to the carrier in the two component development agent is typically 1 to 10 parts by weight based on 100 parts by weight of the carrier.

The development device is either of dry development type or wet development type and of a single color development type or a multi-color development type. The development device suitably includes, for example, a stirrer that triboelectrically charges the toner and a rotary magnet roller.

In the development device, the toner and the carrier are mixed and stirred so that the toner is triboelectrically charged. The toner then stands on the surface of the rotary magnet roller like a filament to form a magnet brush.

Since the magnet roller is provided in the vicinity of the image bearing member, part of the toner forming the magnet brush borne on the surface of the magnet roller is transferred to the surface of the image bearing member by the force of the electric attraction.

As a result, the latent electrostatic image is developed with the toner to form a toner image (toner image) on the surface of the image bearing member.

The development agent accommodated in the development device contains the toner and can be a single component development agent or a two component development agent.

### Measuring of Isolated Amount of External Additive

An ultrasonic vibration method is suitably used to measure the isolation ratio and attachment ratio of silica.

Typically, the isolation ratio is measured by a particle analyzer in which the isolation ratio of titanium atom deriving from an external additive is obtained based on carbon atoms.

In such a method, only the isolation state of the external additive of an initial toner is reflected. Therefore, the isolation ratio after the toner collides with the carrier and the development unit in the development unit is not reflected.

In the ultrasonic vibration method, components of the external additive that are weakly attached to toner particles and immersed in an aqueous solution are separated by a shearing force of the water current caused by stirring of a Homogenizer.

The isolation ratio of the external additive isolated from the toner in the ultrasonic vibration method reflects the isolation ratio of the external additive obtained after the toner receives sufficient stress in the development unit. Therefore, by reducing the isolation ratio within a predetermined range, dropping of the toner from the development sleeve can be reduced even when the toner is under stress in an actual machine running test.

The detail about the ultrasnoic vibration method is as follows.

First, add 0.1 ml of Emulgen 108 (manufactured by Kao Corporation) to 100 ml of deionized water followed by one-minute stirring to prepare a solution A.

Then, add 4 g of sample toner to the solution A, shake the mixture 20 times to wet the toner. After confirming that the dispersion state is free from flotation and separation, leave the liquid for 30 minutes to prepare a liquid B. Next, shake the liquid B five times to disperse the toner. Enter the vibration portion of an ultrasonic homogenizer (VCX 750, manufactured by Sonic Corporation) into the solution B for 2.5 can and vibratio the vibration portion for one minute with an output power of 20 W at 20 kHz to prepare a liquid B. Next, leave the solution C for 10 minutes and then filter it by using a filter paper (100 CIRCLES, manufactured by Toyo Roshi Kaisha, Ltd.). The isolated external additive is present in the filtered liquid.

There is no specific limit to the surface active agent. Polyoxyethylene aliphatic acid ethers are preferable in the present disclosure. Among them, polyoxyethylene aliphatic acid ethers having an aliphatic lauryl based group as a hydrophobic group are preferable in particular. Such ethers having an HLB of from 12.0 to 18.0 are furthermore preferable. These have a high wettability for an hydrophobized external additive, prevent re-attachment of external additives having a weak force of attachment floating in the liquid by a shearing force of the water current caused by a Homogenizer for ultrasonic vibration, and produce a uniform dispersant with less aggregation. Therefore, the obtained liquid is subjected to plasma spectral analysis as it is.

Namely, when other surface active agents are used, clogging and contamination of a sample at a nebulizer and torch portions tend to increase by the operation of the plasma spectral analysis, which leads to troubles in the maintenance of analytical instruments.

Since the commonly used surface active agents (refer to JP-2008-70577-A, JP-H04-9860, etc.) use a phenyl group substituted with an alkyl group as a hydrophobic group, the number of moles added with ethylene oxide which serves as a hydrophilic group determining the solubility of a surface active agent increases. Therefore, prevention of reattachment of the external additive and dispersion function to reduce the aggregation property are not sufficient.

With regard to the isolated amount of the external additive, the filtrate C is weighed to 100 ml with deionized water. Si element is quantitatively measured by ICPS7500 (employing ICP-AES method, manufactured by of Shimadzu Corporation). Sample reference liquids having different concentrations of the contents are prepared using a reference solution for atomic absorption spectrometry (manufactured by Kanto Chemical Co., Inc.) and measured to quantify Ti element and Si element contained in the filtrate C from a calibration curve inside the analytical instrument.

The above-described isolation ratio is represented by a quotient in ppm obtained by dividing the concentration contained in the filtrate with the addition amount.

A plasma spectral analysis ICP-AES method is preferably used to analyze elements contained in the filtrate in terms of measuring accuracy.

The isolated amount in the present disclosure is represented by a concentration of the isolated amount of the external additive from the addition amount thereof mixed with 4 g of toner. The analytical value analyzed by the ICP-AES method is the isolated amount and the isolation ratio can be represented in percentages before and after the test.

Additionally, there is a method of obtaining the isolation ratio by subtraction from the whole after the attachment ratio is analyzed by a fluorescent X-ray analysis in the foregoing test method (refer to JP-H04-264453-A and JP-S61-249059). However, since the isolation ratio is not actually analyzed, the obtained value varies from the actual isolation value and is not resultantly accurate or does not make a sufficient quantitative analysis. Therefore, the isolation is measured by sampling from the filtrate in the present disclosure.

In addition, there is no significant difference by using a surface active agent described in JP-H04-9860-A and JP-2008-70577-A.

Additionally, the isolation ratio is obtained by subtraction from the whole after the analysis on the attachment ratio in the methods described in JP-2006-154387 and JP2006-323368.

It is preferable that the isolated amount of silica from the mother toner mother particle by the ultrasonic vibration method as described above is in the range of 0.1 ppm to 10 ppm, and the isolated amount of titanium oxide is in the range of 0.1 ppm to 5 ppm (toner 4 g/100 ml).

When the isolated amount of silica is too small, the external additive (silica) tends to be embedded in the mother toner particle over time under the stirring stress in the development unit, resulting in deterioration of the fluidity of the toner and reduction of the image density.

To the contrary, when isolated amount of silica is too large, the isolated amount of silica from the mother toner particle tends to increase by stirring over time, thereby increasing carrier spent, degrading the triboelectric charging power of the development agent, and causing the toner to drop from the development sleeve.

When the isolated amount of titanium is too small, the external additive (titanium oxide) tends to be embedded in the mother toner particle, thereby reducing the charging balance control of titanium oxide, resulting in degradation of the chargeability. To the contrary, when the isolated amount of titanium is too large, the isolated amount of titanium oxide from the mother toner particle tends to increase by stirring over time, resulting in degradation of the chargeability. Refer to SEM photographs of FIG. 2.

Further, in the present disclosure, it is desirable that the average primary particle diameters of the above-described two kinds of inorganic particulates are different from each other.

It is known that these external additives are gradually buried in a toner under the stress in the developing process. However, in the case that the particle diameters of the two kinds are different, one inorganic particulate with a lager particle diameter serves as a spacer when the particulate contacts the toner particle surface, a latent image bearing member (typically photoreceptor) and the carrier surface, thereby preventing the inorganic particulate with a smaller particle diameter from being buried in the toner particle. Therefore, the effect of the external additive covering the surface of the toner particle at the initial state lasts for a long time, thereby preventing occurrence of filming.

Further, in the present disclosure, it is desirable that the addition amount of one inorganic particulate with a smaller average primary particle diameter of the two kinds of inorganic particulates is more than that of the other inorganic particulate with a larger average primary particle diameter.

The fewer the addition amount of the external additive with a larger particle diameter and the more the addition amount of the external additive with a smaller particle diameter, the smaller the change of the toner characteristics over time becomes.

This is thought to be because the external additive with a larger particle diameter tends to embed in the toner particle sooner than the external additive with a smaller particle diameter.

Further, regarding the inorganic particulates used in the present disclosure, at least one kind thereof preferably has an average primary particle diameter of 0.03 mm or less in terms of imparting fluidity.

Inorganic particulates that have an average primary particle diameter of 0.03 mm or less imparts fluidity to the toner, makes uniform charging, and improves properties against toner scattering and background fouling.

The addition amount of the above-described external additive is preferably from 0.5 parts by weight to 10 parts by weight and more preferably from 0.8 parts by weight to 4.0 parts by weight relative to 100 parts by weight of mother toner particle.

Therefore, the thin layer of toner on the developing roller becomes uniform, variation of the thickness of the layer is greatly reduced, and further, occurrence of white streaks caused by fusion of the toner to a development agent stirring and coating blade by stirring of the developing roller for a long period is prevented.

When the addition amount of the external additive is outside the above-specified range, the thin layer of the toner on the development roller tends to become nonuniform, thereby failing to conduct uniform development and obtain a uniform image, resulting in occurrence of white streaks caused by fusion of the toner to the development agent stirring and coating blade.

When the addition amount is too small, the fluidity of the toner tends to be not sufficient, thereby failing to supply a required amount of toner to a development roller or develop with toner because the chargeability of the toner is too high.

To the contrary, when the addition amount is too large, charging a toner tends to be not sufficient, thereby causing scattering of toner from the development roller and background fouling.

The above-described mother toner particle means materials other than the external additive, namely, a particle that contains at least a binder resin and a coloring agent in the middle of manufacturing.

An inorganic particulate as the above-described external additive preferably contains a hydrophobic inorganic particulate with a number average particle diameter of from 80 nm to 500 nm and is more preferably hydrophobized silica.

When an inorganic particulate with a large particle diameter is attached to the surface of a mother toner particle, it contributes to improvement of the chargeability and the fluidity upon friction with a carrier and tends not to be embedded in the mother toner particle because of the existence of inorganic particulates with a small particle diameter.

In addition, collision at friction is reduced by the spacer effect described above so that the falling of titanium oxide with a small particle diameter from the toner surface is prevented.

When the number average particle diameter of the inorganic particulate is too small, the particle tends to be buried in the mother toner particle by friction with a carrier and the space effect is reduced, which promotes fall-off of titanium oxide with a small particle diameter from the toner surface and falling of the toner from the sleeve tends to occur over time.

When the number average particle diameter of the inorganic particulate is too large, the particle diameter is so large that the whole area of the inorganic particulate in contact with the toner surface during mixing with the mother toner particle and the inorganic particulate is not sufficiently attached to the toner and left isolated. Therefore, contribution to the fluidity and the chargeability of the toner is reduced. Therefore, a stress applied to toner having a degraded fluidity tends to increase, thereby accelerating carrier spent of titanium oxide and degrading the triboelectric charge power of the carrier, resulting in fall-off of the toner from the development sleeve.

### Toner

The toner includes a binder resin and a coloring agent with optional components.

### Binder Resin

There is no specific limit to the selection of the binder resin and any binder resin can be suitably used. Polyester resins are preferably used in terms of color production and image strength as a binder resin for full color.

Since the color images are formed by overlapping multiple toner layers, cracking or defects of the images occurs or suitable gloss may be lost because of the shortage of the strength of the toner layers.

Therefore, polyester resins that can sustain suitable gloss and an excellent strength are preferably used.

Such polyester resins are typically obtained by esterification reaction between a polyalcohol and a polycarboxylic acid.

Among the monomers constituting such polyesters resins, specific examples of alcohol monomers including monomers having multi-functional groups include, but are not limited to, ethylene glycol, diethylene glycol, triethylene glycol, 1,2-propylene glycol, 1,3-propylene glycol, dials such as 1,4-butadieneol, neopentyl glycol,1,4-butene diol, 1,5-pentane diol, 1,6-hexane diol, bisphenol A, hydrogeneratiod bisphenol adducts of bisphenol A with an alkylene oxide, other diols, sorbitol, 1,2,3,6-hexanetetrol, 1,4-sorbitan, pentaerythritol, dipentaerythritol, tripentaerythritol, 1,2,4-butane triol, 1,2,5-pentane triol, glycerol, diglycerol, 2-methylpropane triol, 2-methyl-1,2,4-butane triol, trimethylol ethane, trimethylol propane, 1,3,5-trihydroxy benzene, and other tri- or higher alcohols.

Among these monomers constituting the polyester resins, the monomer essentially constituting of an adduct of bisphenol A with an alkylene oxide is preferably used.

When such an adduct of bisphenol A with an alkylene oxide is used as the constitutional monomer, a polyester having a relatively high glass transition temperature is obtained because of the characteristics of the skeleton of bisphenol A. This contributes to improvement of the copy blocking resistance and high temperature preservability.

In addition, existence of alkyl groups on both sides of the skeleton of bisphenol A serves as soft segments in the polymer, thereby improving the color production and the image strength during fixing.

Among the adducts of bisphenol A with an alkylene oxide, adducts having an ethylene group or a propylene group are preferably used.

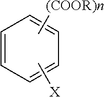

In the chemical structure, n represents an integer of 2 or greater, R represents a hydrogen atom, an alkyl group having 1 to 18 carbon atoms, or an alkenyl group having 2 to 18 carbon atoms, and X represents a hydrogen atom or an alkyl group having 1 to 3 carbon atoms.

Specific examples of the acid monomers including monomers having multi-functional groups among the monomers constituting the polyester resins include, but are not limited to, maleic acid, fumaric acid, citraconic acid, itaconic acid, glutaconic acid, phtahlic acid, isophthalic acid, terephthalic acid, cyclohexane dicarboxylic acid, succinic acid, adipic acid, sebacic acid, azelaic acid, maronic acid, alkenyl succinic acids or alkyl succinic acids such as n-dodecenyl succinic acid and n-dodecyl succinic acid, anhydrides thereof, alkyl esters, other dicarboxylic acids, 1,2,4-naphthalene tricarboxylic acid, 1,2,4-butane tricarboxylic acid, 1,2,5-hexane tricarboxylic acid, 1,3-dicarboxyl-2-methyl-methylene carboxy propane, tetra(methylenecarboxyl)methane, 1,2,7,8-octane tetracarboxylic acid, EnPol trimer acid, and anhydrides thereof, alkyl esters, alkyenyl esters, aryl esters, and other tri- or higher carboxylic acids.

Specific examples of the alkyl esters, alkenyl esters, and aryl esters inlcude, but are not limited to, 1,2,4-benzene triethyl tricarbonate, 1,2,4-benzene trimethyl tricarbonate, 1,2,4-benzene tri-n-butyl tricarbonate, 1,2,4-benzene isobutyl tricarbonate, 1,2,4-benzene tri-n-octyl tricarbonate, 1,2,4-benzene tri-2-ethylhyxyl tricarbonate, 1,2,4-benzene tribenzyl tricarbonate, and 1,2,4-benzene tris (4-isopropylbenzyl)tricarbonate.

There is no specific limit to the method of manufacturing the polyester resins and a known method can be used for esterification reaction.

In addition, a known method can be suitably used for ester exchange reaction. Any ester exchange catalyst can be used in such a method.

Specific examples thereof include, but are not limited to, magnesium acetate, zinc acetate, manganese acetate, calcium acetate, tin acetate, lead acetate, and titan tetrabuthoxide.

Any known method can be suitably used for polycondensation reaction. Any polymeization catalyst can be used in such a method.

Specific examples thereof include, but are not limited to, antimony trioxide and germanium dioxide.

### SYNTHESIS EXAMPLE

Next, the present disclosure is described in detail with reference to Examples but not limited thereto.

### Synthesis Example of Polyester Resins for Use in Example 4 (Described Later)

### Polyester Resin 1

3 mol of trimethylol propane, 1 mol of fumaric acid, 1 mol of isophthalic acid, and 0.2 mol of tin octylate (II) are placed in a reaction container equipped with a condenser, a stirrer, and a nitrogen introduction tube to conduct reaction at 230° C. for two hours in nitrogen stream while distilling away water produced during the reaction.

Next, the reaction continues for one hour under a reduced pressure of from 5 to 20 mmHg and then 0.5 mol of trimellitic anhydride is added. Subsequent to a two-hour reaction at a normal pressure with hermetically sealed, the resultant is cooled down to room temperature and pulverized to obtain a non-linear polyester resin 1.

The resin 1 contains 20% of THF insoluble component and has a peak top molecular weight of 12,700.

### Polyester Resin 2

1 mol of an adduct of bisphenol A with proplyene oxide, 1 mol of an adduct of bisphenol A with ethylene oxide, 1.5 mol of adipic acid, 0.5 mol of cyclohexane dicarboxylic acid, and 1 mol of dilaurylate tin octylate (II) are placed in a reaction container equipped with a condenser, a stirrer, and a nitrogen introduction tube to conduct reaction at 230° C. for two hours in nitrogen stream while distilling away water produced during the reaction.

Next, the reaction continues for three hours under a reduced pressure of from 5 to 20 mmHg. Subsequent to cooling down to room temperature, the resultant is pulverized to obtain a non-linear polyester resin 2. The resin 2 contains no THF insoluble component and has a peak top molecular weight of 4,500.

### Polyester Resin 3

1 mol (455 g) of phenol novolac resin having a nuclear number in one molecule of 4.4 and a softening point of 81° C. is placed in an autoclave and air in the reaction container is replaced with nitrogen.

Next, 1 mol of titanium dihydroxy bistriethanol aminate is added and then 3 mol of ethylene glycol is gradually press fit while the temperature is held at 120° C. to complete the reaction. Volatiles are removed to obtain oxyalkylene ether (NE1) of novolac type phenol resin.

2.1 mol (735 g) of polyoxypropylene (2,2)-2,2-bis(4-hydroxyphenyl), 0.9 mol of NE1 and 3 mol of terephthalic acid are placed in a reaction container equipped with a thermometer, a stirrer having a torque detector, a condenser, and a nitrogen introducing tube to conduct reaction at 230° C. in nitrogen stream.

When the reactant tends to have a transparent feeling, the reaction temperature is dropped to 200° C. to proceed polyesterification reaction with a reduced pressure.

The viscosity of the reactant gradually increases and the reaction is terminated when the torque of the stirrer indicates a predetermined value. Thereafter, the reactant is removed and cooled down quickly to obtain a polyester resin 3.

The polyester resin 3 contains 28% of THF insoluble component and has a peak top molecular weight of 5,200.

### Hybrid Resin 4

20 mol of styrene and 5 mol of n-butylmethacrylate as a polyaddition reaction monomer and 1 mol of t-butyl hydroperoxide as a polymerizatio ninitiator are placed in a dropping funnel.

30 mol of phthalic acid as a both reactive monomer for polyaddition and polycondensation, 10 mol of trimellitic anhydride, 10 mol of bisphenol A (2,2) propyleneoxide, and 10 mol of bisphenol A (2,2) ethyleneoxide as polycondensation monomers, and 8 mol of disteraoxy tin (II) are placed in a flask equipped with a stainless stirring bar, fluidity type condenser, a nitrogen gas introducing tube, and a thermometer. The preliminary mixture of the polyaddition materials specified above in the dropping funnel is dropped therefrom to the flask in five hours while stirring at 150° C. in nitrogen atmosphere.

After dropping, the resultant is aged for five hours while keeping the temperature at 150° C. Then, the temperature is raised to 230° C. to obtain a hybrid resin 4.

The hybrid resin 4 contains no THF insoluble component and has a peak top molecular weigh of 9,500.

### Styrene Acrylic Resin 5

2,000 g of deionized water and 500 g of styrene and 100 g of glycidyl acrylate as monomers, 50 g of a radical polymerization initiator, and 10 g of dodecenyl benzene sodium sulfonate as a dispersion agent are set in a flask equipped with a condenser, a stirrer, a gas introducing tube, and a thermometer.

These are heated to 90° C. while replacing with nitrogen and stirring to conduct reaction for 12 hours.

The obtained polymerized matter is washed with water and dried at normal temperature at 10 torr to obtain powder (styrene acrylic resin 5) having a volatile component of 1% or less.

The styrene acrylic resin 5 contains no THF insoluble component and has a peak top molecular weigh of 4,000.

### Coloring Agent

There is no specific limit to the selection of the coloring agent and any known dyes and pigments can be suitably used. Specific examples of the coloring agents include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These can be used alone or in combination.

The content of the coloring agent in the toner materials is preferably from 1% to 15% by weight and more preferably from 3% to 10% by weight.

When the content of the coloring agent is too small, the coloring performance of the toner tends to deterioratio. To the contrary, when the content of the coloring agent is too great, dispersion of a pigment in the toner tends to be insufficient, thereby degrading the coloring performance and the electric characteristics of the toner.

The coloring agent and the resin can be used in combination as a master batch. Specific examples of such resins include, but are not limited to, polyester, polymers of styrene or its substitution products, styrene-based copolymers, polymethyl methacrylate, polybutyl methacrylate, polyvinyl chloride, polyvinyl acetate, polyethylene, polypropylene, epoxy resins, epoxy polyol resins, polyurethane, polyamide, polyviny butyral, polyacrylic acid resin, rosin, modified rosin, terpene resin, aliphatic hydrocarbon resins, alicyclic hydrocarbon resins, aromatic petroleum resins, chlorinated paraffin, and paraffin wax.

These can be used alone or in combination.

Specific examples of polymers of styrene or its substitution products include, but are not limited to, polystyrene, poly(p-chlorostyrene), and polyvinyl toluene.

Specific examples of the styrene-based copolymers include, but are not limited to, styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers.

The master batch can be manufactured by applying a high shearing force to the resin and the coloring agent for mixing or kneading.

In this case, an organic solvent can be used to boost the interaction between the coloring agent and the resin.

In addition, so-called flushing methods and a wet cake of the coloring agent can be used as they are, which is advantageous in that there is no need to drying.

The flushing method is a method in which a water paste containing water of a coloring agent is mixed or kneaded with an organic solvent and the coloring agent is transferred to the resin side to remove water and the organic solvent.

High shearing dispersion devices such as a three-roll mill, etc. can be used for mixing or kneading.

The toner of the present disclosure optionally contains known components such as a releasing agent, a charge control agent, and a magnetic material.

### Releasing Agent

It is preferable to contain a wax in the manufactured toner as the releasing agent to impart the releasing property to the toner.

The melting point of the wax is preferably from 40° C. to 120° C. and more preferably from 50° C. to 110° C. When the melting point of the toner is too high, the fixing property at a low temperature tends to be insufficient. When the melting point of the toner is too low, the offset resistance and the durability tend to deteriorate. The melting point of the wax can be obtained by differential scanning calorimeter measurement (DSC) method.

That is, the melting peak value is determined as the melting point when a sample of several mg is heated at a constant temperature rising speed (for example, 10° C./min).

Specific examples of the wax include, but are not limited to, solid paraffin wax, microcrystalline wax, rice wax, aliphatic acid amide-based wax, aliphatic acid-based wax, aliphatic mono-ketones, aliphatic acid metal salt-based wax, aliphatic acid ester-based wax, partial saponified aliphatic acid ester-based wax, silicone varnish, higher alcohols, and carnauba wax.

In addition, polyolefins such as polyethylene having a small molecular weight and polypropylene can be also used.

Among these, polyolefins having a softening point of from 70° C. to 150° C. according to the ring-and-ball method are preferable and polyolefins having a softening point of from 120° C. to 150° C. are particularly preferable. In addition to synthesis waxes, natural waxes such as carnauba waxes can be used. A combinational use of synthesis resins and natural waxes are preferable to take advantages of the natural wax.

### Charge Control Agent

Specific examples of the charge control agents include, but are not limited to, nigrosine dyes, triphenylmethane dyes, chrome containing metal complex dyes, chelate pigments of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing surface active agents, metal salts of salicylic acid, and metal salts of salicylic acid derivatives. These can be used alone or in combination.

Marketed products of the charge control agents can be used. Specific examples thereof include, but are not limited to, BONTRON P-03 (nigrosine-based dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE PR (triphenyl methane derivative), COPY CHARGE NEG VP2036 and NX VP434 (quaternary ammonium salt), which are manufactured by Hoechst AG; LRA-901 and LR-147 (boron complex), which are manufactured by Japan Carlit Co., Ltd.; copper phthalocyanine, perylene, qinacridone, azo-based pigments, and polymers having a functional group such as a sulfonate group, a carboxyl group, a quaternary ammonium basic group, etc.

The content of the charge control agent is preferably from 0.1 to 10 parts by weight and more preferably from 0.2 to 5 parts by weight based on 100 parts by weight of the binder resin specified above.

When the content is too low, the charge control property is not easily obtained. When the content is too high, the toner tends to have an excessive chargeability, thereby decreasing the effect of the main charge control agent, increasing the force of electrostatic attraction with the development roller, and inviting deterioration of the fluidity of the toner and a decrease of the image density.

### Magnetic Material

The toner of the present disclosure optionally contains magnetic material and serves as a magnetic toner. Specific examples of the magnetic materials include, but are not limited to, oxidized iron such as magnetite, hematite and ferrite, metals such as iron, cobalt and nickel, or an alloyed metal of the specified metal with aluminum, cobalt, copper, lead, magnesium, tin, zinc, antimony, beryllium, bismuth, cadmium, calcium, manganese, selenium, titanium, tungsten and vanadium, and a mixture thereof.

These can be used alone or in combination. The content of the magnetic material is preferably from 5 to 150 parts by weight based on 100 parts by weight of the binder resin.

There is no specific limit to the manufacturing method of the toner of the present disclosure and any known pulverized method and polymerization method can be suitably used.

Such an applicable pulverization method includes, for example, a mixing process in which at least a binder resin and a toner component containing a coloring agent are mechanically mixed, a process of melting and mixing and kneading, a pulverization process, and a classification process.

In addition, a method which includes returning powder other than the product obtained in the pulverization or the classification process to the mixing process and the melting and mixing and kneading process for recycling is also suitably applicable.

The powder (by-product) other than the product represents particulates or coarse particles other than the toner particles treated as the marketed product having a desired particle diameter obtained in the pulverization process after the melting and mixing and kneading process or in the following air classification process.

Such by-products are mixed in the mixing process of melting and mixing and kneading process preferably in an amount of from 1 to 20 parts by weight based on 100 parts by weight of the main material.

There is no specific limit to the mixing process of mechanically mixing the toner component containing at least the binder resin and the coloring agent and the mixing process of mechanically mixing the toner component containing the binder resin, the coloring agent, and the charge control agent. A typical mixer having a rotary blade can be used in typical conditions.

Subsequent to the mixing process, the mixture is placed in a mixing and kneading machine for melting and mixing and kneading.

One-axis or two axis continuous mixing and kneading machines or batch type mixing and kneading machines can be used as the melting and mixing and kneading machine.

Specific examples thereof include, but are not limited to, KTK type two axis extruders (manufactured by KOBE STEEL., LTD.), two axis extruders (manufactured by KCK), PCM type two-axis extruders (manufactured by Ikegai Corp.), and Ko-kneaders manufactured by Buss).

These melting and mixing and kneading operations are required to be conducted under suitable conditions not to sever the molecular chain of the binder resins.

To be specific, the temperature in the melting and mixing and kneading operation is determined referring to the softening point of the binder resin. When the temperature is too low relative to the softening point, the molecular chain tends to be severely severed. When the temperature is too high relative to the softening point, dispersion tends not to proceed soon.

If the melting and mixing and kneading process are complete, the kneaded materials are pulverized. In the pulverization process, it is preferable to coarsely pulverize the materials first followed by fine pulverization.

In this process, kneaded materials are pulverized by collision with a collision board in a jet stream, collision among particles in a jet stream, and pulverization at narrow gaps between a stator and a rotor that is mechanically rotating, etc.

After the pulverization process, the pulverized materials are classified by centrifugal to manufacture a development agent having a predetermined particle diameter, for example, an average particle diameter of from 4 μm to 20 μm.

To manufacture the toner of the present disclosure, external additives are admixed with the thus obtained mother toner particles to improve the fluidity, the preservability, the development property, and the transfer property.

Although mixing of the external additive is conducted by a typical powder mixer, a mixer having a jacket, etc. is preferable to adjust the internal temperature.

To change the history of the burden applied to the external additive, adding the external additive in the midstream or little by little during mixing is suitable.

It is also suitable to change the number of rotation, rolling speed, time, temperature, etc. of the mixer.

Heavy burden followed by relatively light burden or vice versa is applicable.

An example of the mixing facilities is preferably a Henschel Mixer. Specific conditions are that the temperature in the jacket is controlled to be in the range of from 25° C. to 35° C. and the number of rotation of the stirring blade is around 1,000 rpm. When the number of rotation is too great, heat of friction increases, which is dangerous. Furthermore, although the mixing time depends on the amount of toner, repeating a cycle of 30 second operation (mixing) and 60 second cooling-down once to ten times is preferable. For example, if the cooling-down time is shorter than the operation time, heat of friction easily increases and the external additives tends to be buried, causing deterioration of the toner fluidity and increasing agglomeration of the toner particles.

If the number of repetition of the cycle is too few, the force of attachment tends to be weak and the obtained development agent tends to have problems such as carrier spent and deterioration of the quality targeted by the present disclosure.

In addition, the mixing efficiency can be improved by providing an air stream source to mix and disperse the powder layer flowing in the mixer from the lateral side. The size of the source can be about one third of the diameter of the rotation blade.

That is, the rotation of the mixing blade at a high speed causes a swirl flow, which mixes at least two kinds of particles. A suitable attachment strength is determined by the circumferential velocity of front edge and the number of rotations of the mixing blade.

### Two Component Development Agent

The toner of the present disclosure can be used as a two component development agent using a carrier.

Iron powder, ferrite, magnetite, glass beads, and any typical material can be used as the carrier.

Carriers that are coated of a resin can be also suitably used.

Specific examples of the resins include, but are not limited to, polyfluorocarbon, polyvinyl chloride, polyvinylidene chloride, phenol resins, polyvinyl acetal, acrylic resins, and silicone resins.

Among these, silicone coated carriers are excellent in terms of the working life of a development agent.

Electroconductive powder, etc., can be optionally contained in the coating resin.

Specific examples of such electroconductive powder include, but are not limited to, metal powder, carbon black, titanium oxide, tin oxide, and zinc oxide. The average particle diameter of such electroconductive powder is preferably 1 μm or greater.

When the average particle diameter is too large, controlling electric resistance may become difficult. The mixing ratio of the toner to the carrier in the two component development agent is typically 0.5 to 20.0 parts by weight based on 100 parts by weight of the carrier.

### Process Cartridge

The process cartridge for use in the present disclosure includes at least an image bearing member that bears a latent electrostatic image, a development device that develops the latent electrostatic image borne on the image bearing member with toner to obtain a toner image, and other optional suitably selected devices.

The development device includes a development agent container accommodating the toner or a development agent containing the toner, a development agent bearing member that bears and transfers the toner or the development agent accommodated in the development agent container, and other optional devices such as a layer thickness regulator that regulates the layer thickness of the toner borne on the development agent bearing member.

The process cartridge described above is detachably attachable to various kinds of electrophotographic image forming apparatuses and preferably detachably attachable to the image forming apparatus of the present disclosure described later.

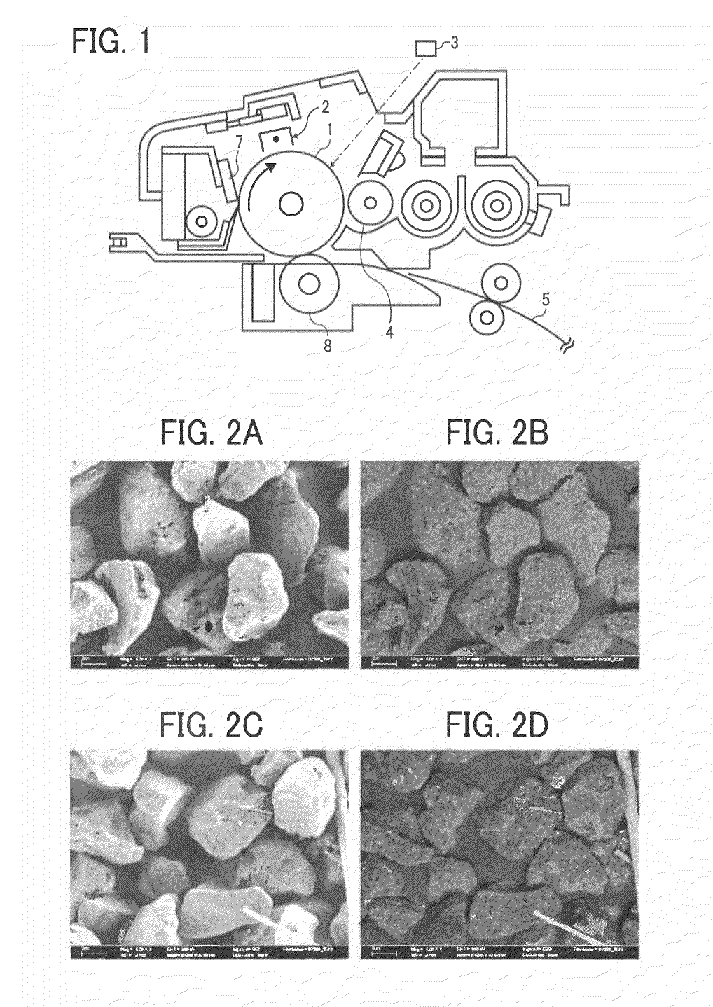

The process cartridge includes, for example, an image bearing member 1, a charging device 2, a development agent 4, a transfer roller 8, a cleaning unit 7, and other optional devices as illustrated in FIG. 1. In FIG. 1, the numeral references 3 and 5 represent beams of light by an irradiation device and a recording medium, respectively.

Next, the image formation process by the process cartridge illustratiod in FIG. 1 is described. The image bearing member 1 is charged by the charging device 2 and irradiated with the beams of light 3 by an irradiation device (not shown) while rotating in the direction indicated by an arrow to form a latent electrostatic image corresponding to the irradiation image on the surface of the image bearing member 1.

This latent electrostatic image is developed by the development device 4 and the obtained toner image is transferred by the transfer roller 8 to the recording medium 5 for printout.

The surface of the image bearing member 1 after image transfer is cleaned by the cleaning unit 7 and discharged by a discharging device (not shown) to be ready for the next image formation process again.

The surface of the toner particle from which the external additives are isolated by the ultrasonic vibration method described above is illustrated in FIG. 2. As seen in the SEM photographs of Example 1 in FIG. 2A illustrating an reflection electron image and FIG. 2B illustrating a secondary electron image, the external additives are still attached to the entire of the toner in spite of application of the shearing force of the water current.

It is found that the external additives are detached in a great amount in Comparative Example 1 described later in which the ratio of the mixing time to the cooling-down time is small and the number of repeating the mixing cycle is fewer.

In the present disclosure, mixing is conducted by providing a cooling-down time after mixing with a lower energy level in a predetermined ratio of the mixing time to the cooling-down time instead of simply providing a high and strong energy for mixing. Furthermore, it is also found that as the number of repeating the mixing cycle of operation (mixing) and cooling-down increases, the external additive is more uniformly and strongly attached to the toner particles.

### Image Forming Method

The image forming method of the present disclosure includes a latent electrostatic image forming process, a development process, a transfer process, and a fixing process with optional processes such as a cleaning process, a discharging process, a recycling process, and a control process.

The image forming apparatus of the present disclosure includes a latent electrostatic image bearing member, a latent electrostatic image forming device, a development device, a transfer device, and a fixing device with optional devices such as a cleaning device, a discharging device, a recycling device, and a control device.

The image forming method related to the present disclosure is suitably performed by the image forming apparatus of the present disclosure. The charging process is performed by the charging device. The irradiation process is performed by the irradiation device. The development process is performed by the development device. The transfer process is performed by the transfer device. The cleaning process is performed by the cleaning device. The protection layer formation process is performed by the protective agent application device. The fixing process is suitably performed by the fixing device. The other optional processes are performed by the corresponding optional devices.

### Latent Electrostatic Image Formation Process and Latent Electrostatic Image Forming Device

The latent electrostatic image forming process is a process of forming a latent electrostatic image on a latent electrostatic image bearing member.

There is no specific limit to the (latent electrostatic) image bearing member (also referred to as photoreceptor or photoconductor) with regard to material, form, structure, size, etc. and any known image bearing member can be suitably selected. An image bearing member having a drum form is preferred. Also, an inorganic image bearing member formed of amorphous silicone or selenium and an organic image bearing member formed of polysilane or phthalopolymethine are selected in terms of materials. Among these, amorphous silicon, etc. is preferred in terms of long working life.

Latent electrostatic images are formed by, for example, uniformly charging the surface of the image bearing member and irradiating the surface according to the obtained image information using the latent electrostatic image forming device.

The latent electrostatic image forming device includes at least a charger which uniformly charges the surface of the image bearing member, an irradiator which irradiates the surface of the image bearing member according to the obtained image information.

The surface of the image bearing member is charged by, for example, applying a voltage to the surface of the image bearing member with the charger.

There is no specific limit to the charger and any known charger can be selected. A known contact type charger having an electroconductive or semi-electroconductive roll, brush, film, rubber blade, etc. and a non-contact type charger such as a corotron or a scorotron which uses corona discharging can be used.

The irradiation is conducted by, for example, irradiating the surface of the image bearing member with the irradiator according to image data.

Specific examples of such irradiators include, but are not limited to, a photocopying optical system, a rod lens array system, a laser optical system, and a liquid crystal shutter optical system.

As to the present disclosure, the rear side irradiation system in which an image bearing member is irradiated from the rear side thereof can be also employed.

### Development Process and Development Device

The development process is a process of forming a toner image by developing the latent electrostatic image with the toner of the present disclosure.

The toner image is formed by, for example, developing the latent electrostatic image by the development device with the toner of the present disclosure.

Any known development device that can perform development with the toner of the present disclosure is suitably selected. For example, a development device that accommodates the toner of the present disclosure and includes a development unit which attaches the toner to the latent electrostatic image in a contact or non-contact manner can be suitably used.

The development device is either of dry development type or wet development type and of a single color development type or a multi-color development type. The development device suitably includes, for example, a stirrer that triboelectrically charges the toner or the development agent, and a rotary magnet roller.

In the development device, the toner and a carrier are mixed and stirred to triboelectrically charge the toner. The toner is then held on the surface of the rotary magnet roller like a filament to form a magnet brush. Since the magnet roller is provided in the vicinity of the image bearing member, part of the toner forming the magnet brush borne on the surface of the magnet roller is transferred to the surface of the image bearing member by the force of the electric attraction.

As a result, the latent electrostatic image is developed with the toner and visualized as a toner image on the surface of the image bearing member.

The development agent accommodated in the development device is the development agent containing the toner of the present disclosure and can be a single component development agent or a two component development agent.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

### Example 1

### Prescription of Toner

Polyester Resin: 100 parts (number average molecular weight Mn: 4,300 Weight average molecular weight Mw: 12,700, glass transition temperature Tg: 55° C.
Carbon black (MA100, manufactured by Mitsubishi Chemical Corporation): 3 parts
Charge control agent (BONTRON E-84, manufactured by Orient Chemical Industries Co., Ltd.): 1 part
Carnauba wax: 3 parts

### Manufacturing of Mother Toner

The mixture of the prescription of toner is mixed and kneaded by an extruder, pulverized by a jet mill, and classified by an air classifier to obtain mother toner particles having an volume average particle diameter Dv of 4.9 μm, a ratio of Dv/Dn of the volume average particle diameter Dv to the number average particle diameter Dn of 1.15, and a particle size distribution with a content ratio of toner particles having a particle diameter of 4.0 μm or less of 55% by quantity and a content ratio of toner particles having a particle diameter of 3.2 μm or less of 32% by quantity.

### Mixing Process of External Additive

### Dispersion Stage

30 kg of the obtained classified mother toner particles is weighed and placed in the mixing room of a Henschel type super mixer (Henschel Mixer 20B, manufactured by NIPPON COKE & ENGINEERING. CO., LTD.). 0.1 kg of silica (RZD 972, manufactured by Tokuyama Corporation) having a specific surface area of 240 m2/g and 0.2 kg of titanium oxide (MT150AFM, manufactured by Tayca Corporation) are placed therein for mixing with a low energy first.

The temperature in the jacket at this point of time is controlled to be in the range of from 25° C. to 30° C.

The number of rotation of the stirring blade for the low energy mixing is 400 rpm and a cycle of a 60 second operation (mixing) and a ten second cooling-down is repeated once.

### Attachment Stage

Next, the mixture is subjected to mixing with a high energy. The temperature in the jacket at this point of time is controlled to be in the range of from 25° C. to 30° C. The number of rotation of the stirring blade for the high energy mixing is 1,000 rpm and a cycle of a 60 second operation and a ten second cooling-down is repeated nine times to obtain a toner of Example 1.

TABLE 2

| | Mixing step of external additive | | | |
|---|---|---|---|---|
| | Dispersion stage (low- | | Attaching stage (high- | |
| Preferable | energy mixing) | | energy mixing) | |
| condition | Mixing | Cooling down | Mixing | Cooling down |
| Time (sec) | 60 | 10 | 60 | 10 |
| Temperature | 25-30 | 25-30 | 25-30 | 25-30 |
| (° C.) | | | | |
| Number of | 400 | 0 | 1000 | 0 |
| rotations | | | | |
| (rpm) | | | | |

| | | |
|---|---|---|
| Number of | once | nine times |
| cycles | | |

The amount and the ratio of the isolated silica in the obtained toner are measured as follows.

The results are shown in Table 5.

### Isolation Ratio of Silica

First, 0.1 ml of Emulgen 108 manufactured by Kao Corporation added to 100 ml of deionized water followed by a one-minute stirring to prepare a solution A.

Next, 4 g of the toner of Example 1 is added to the solution A and shaken 20 times to wet the toner. After the dispersion state is confirmed to be free from floating and separation in the liquid, the liquid is left for 30 minutes to prepare a liquid B.

Next, the liquid B is shaken five times to disperse the toner. The vibration portion of an ultrasonic homogenizer (VCX 750, manufactured by Sonic Corporation) is entered into the liquid B for 2.5 can and vibrated for one minute with an output power of 20 W at 20 kHz to prepare a liquid C.

Next, the solution C is left for 10 minutes and then filtered by using filter paper (100 CIRCLES, manufactured by Toyo Roshi Kaisha, Ltd.).

Next, the filtrate C is weighed to be 100 ml by deionized water and Si element is quantified by ICPS7500 (manufactured by Shimadzu Corporation). The used reference solutions having different concentration of 0 ppm, 10 ppm, and 20 ppm are prepared based on the reference solution for atomic absorption analysis (manufactured by Kanto Chemical Co., Inc.). Si element contained in the filtrate C is quantified together with the reference solutions.

The isolation ratio of the silica in the obtained toner is shown in Table 5.

### Example 2

### Prescription of Toner and Manufacturing of Mother Toner

Toner is manufactured in the same manner as in Example 1.

### Mixing Process of External Additive

30 kg of the obtained classified mother toner particle is weighed and placed in the mixing room of a Henschel type super mixer (Henschel Mixer 20B, manufactured by NIPPON COKE & ENGINEERING. CO., LTD.). 0.15 kg of silica (RZD 972, manufactured by Tokuyama Corporation) having a specific surface area of 240 m2/g and 0.2 kg of titanium oxide (MT150AFM, manufactured by Tayca Corporation) are placed therein for mixing with a low energy first. The temperature in the first jacket at this point of time is controlled to be in the range of from 25° C. to 30° C.

The number of rotation of the stirring blade for the low energy mixing is 400 1μm and a cycle of a 60 second operation and a 10 second cooling-down is repeated once.

The temperature in the jacket at this point of time is controlled to be in the range of from 25° C. to 30° C.

Next, the mixture is subjected to mixing with a high energy.

The temperature in the jacket at this point of time is controlled to be in the range of from 25° C. to 30° C. The number of rotation of the stirring blade for the high energy mixing is 1,000 rpm and a cycle of a 60 second operation and a 20 second cooling-down is repeated nine times to obtain a toner of Example 2.

TABLE 3

| | Mixing specification | | | |
|---|---|---|---|---|
| | Mixing process of external additive | | | |
| | Dispersion stage (low-energy mixing) | | | |
| | Mixing | | Cooling down | |
| Examples and | | Number of | | Number of |
| Comparative | Temperature | rotation | Temperature | rotation |
| Example | (° C.) | (rpm) | (° C.) | (rpm) |
| Example 1 | 25-30 | 400 | 25-30 | 0 |
| Example 2 | 25-30 | 400 | 25-30 | 0 |
| Example 3 | 25-30 | 400 | 25-30 | 0 |
| Example 4 | 25-30 | 400 | 25-30 | 0 |
| Example 5 | 25-30 | 400 | 25-30 | 0 |
| Example 6 | 25-30 | 400 | 25-30 | 0 |
| Example 7 | 25-30 | 400 | 25-30 | 0 |
| Example 8 | 25-30 | 400 | 25-30 | 0 |
| Example 9 | 25-30 | 400 | 25-30 | 0 |
| Comparative | — | — | — | — |
| Example 1 | | | | |
| Comparative | — | — | — | — |
| Example 2 | | | | |
| Comparative | — | — | — | — |
| Example 3 | | | | |
| Comparative | — | — | — | — |
| Example 4 | | | | |
| Comparative | — | — | — | — |
| Example 5 | | | | |
| Comparative | — | — | — | — |
| Example 6 | | | | |
| Comparative | — | — | — | — |
| Example 7 | | | | |

| | Mixing specification | | | | |
|---|---|---|---|---|---|
| | Mixing process of external additive | | | | |
| | Attaching stage (high-energy mixing) | | | | Number of cycles |
| | Mixing | | Cooling down | | (number of cycles in |
| Examples and | | Number of | | Number of | Dispersion stage + |
| Comparative | Temperature | rotation | Temperature | rotation | number of cycles in |
| Examples | (° C.) | (rpm) | (° C.) | (rpm) | Attaching stage |
| Example 1 | 25-30 | 1000 | 25-30 | 0 | 10 (1 + 9) |
| Example 2 | 25-30 | 1000 | 25-30 | 0 | 10 (1 + 9) |
| Example 3 | 25-30 | 1000 | 25-30 | 0 | 10 (1 + 9) |
| Example 4 | 25-30 | 1000 | 25-30 | 0 | 8 (1 + 7) |
| Example 5 | 30-34 | 900 | 30-34 | 0 | 6 (1 + 5) |
| Example 6 | 30-34 | 900 | 30-34 | 0 | 6 (1 + 5) |
| Example 7 | 30-34 | 900 | 30-34 | 0 | 6 (1 + 5) |
| Example 8 | 20-30 | 800 | 20-30 | 0 | 6 (1 + 5) |
| Example 9 | 20-30 | 800 | 20-30 | 0 | 8 (1 + 7) |
| Comparative | 35-40 | 800 | 35-40 | 0 | 3 (0 + 3) |
| Example 1 | | | | | |
| Comparative | 35-40 | 800 | 35-40 | 0 | 3 (0 + 3) |
| Example 2 | | | | | |
| Comparative | 35-40 | 800 | 35-40 | 0 | 2 (0 + 2) |
| Example 3 | | | | | |
| Comparative | 35-40 | 800 | 35-40 | 0 | 2 (0 + 2) |
| Example 4 | | | | | |
| Comparative | 35-40 | 1200 | 35-40 | 0 | 2 (0 + 2) |
| Example 5 | | | | | |
| Comparative | 35-40 | 1200 | 35-40 | 0 | 5 (0 + 5) |
| Example 6 | | | | | |
| Comparative | None | 2500 | None | — | 0 |
| Example 7 | | | | | |

The amount and the ratio of isolated silica in the obtained toner are measured in the same manner as in Example 1. The results are shown in Table 5.

### Example 3

### Prescription of Toner and Manufacturing of Mother Toner

Toner of Example 3 is manufactured in the same manner as in Example 1.

### Mixing Process of External Additive

30 kg of the obtained classified mother toner particle is weighed and placed in the mixing room of a Henschel type super mixer (Henschel Mixer 20B, manufactured by NIPPON COKE & ENGINEERING. CO., LTD.). 0.1 kg of silica (RZD 972, manufactured by Tokuyama Corporation) having a specific surface area of 240 m2/g is placed therein to conduct mixing with a low energy first and then 0.2 kg of titanium oxide (MT150AFM, manufactured by Tayca Corporation) is added to the mixing room for mixing with a high energy.

The temperature in the jacket at this point of time is controlled to be in the range of from 25° C. to 30° C.

The number of rotation of the stirring blade for the low energy mixing is 400 rpm and a cycle of a 60 second operation and a 10 second cooling-down is repeated once.

The number of rotation of the stirring blade for the high energy mixing is 1,000 rpm and a cycle of a 60 second operation and a 20 second cooling-down is repeated nine times to obtain a toner of Example 3.

The amount and the ratio of isolated silica in the obtained toner are measured in the same manner as in Example 1. The results are shown in Table 5.

### Example 4

### Prescription of Toner

### Polyester Resins

Polyester Resin 1 of Synthesis Example: 60 parts
Polyester Resin 2 of Synthesis Example: 20 parts
Polyester Resin 3 of Synthesis Example: 20 parts
Quinacridone-based magenta (C.I. Pigment Red 122): 3 parts
Charge control agent (BONTRON E-84, manufactured by Orient Chemical Industries Co., Ltd.): 1 part
Mixture of carnauba wax and rice wax with a ratio of 60% to 40%: 4 parts

### Manufacturing of Mother Toner

The mixture of the prescription of toner is mixed and kneaded by an extruder, pulverized by a jet mill, and classified by an air classifier to obtain toner particles having an volume average particle diameter Dv of 4.71 μm, a ratio of Dv/Dn of the volume average particle diameter Dv to the number average particle diameter Dn of 1.24, a content ratio of the number of toner particles having a particle diameter of 4.0 μm or less of 66%, a content ratio of the number of toner particles having a particle diameter of 3.2 μm or less of 33%, and a volume content ratio of toner particles having a particle diameter of 8 μm or less of 1.8%.

### Mixing Process of External Additive

30 Kg of the obtained classified magenta mother toner is weighed and placed in the mixing room of a Henschel type super mixer (Henschel Mixer 20B, manufactured by NIPPON COKE & ENGINEERING. CO., LTD.). 0.1 kg of silica (RZD 972, manufactured by Tokuyama Corporation) having a specific surface area of 240 m2/g and 0.2 kg of titanium oxide (MT150AFM, manufactured by Tayca Corporation) are placed therein for mixing with a low energy first.

The temperature in the jacket at this point of time is controlled to be in the range of from 25° C. to 30° C.

The number of rotation of the stirring blade for the low energy mixing is 400 rpm and a cycle of a 60 second operation and a 10 second cooling down is repeated once.

Next, the mixture is subjected to mixing with a high energy.

The temperature in the first jacket at this point of time is controlled to be in the range of from 25° C. to 30° C.

The number of rotation of the stirring blade for the high energy mixing is 1,000 rpm and a cycle of a 110 second operation and a 60 second cooling down is repeated seven times to obtain a magenta toner of Example 4.

The amount and the ratio of isolated silica in the obtained toner are measured in the same manner as in Example 1. The results are shown in Table 5.

### Example 5

### Prescription of Toner

Polyester Resin: 100 parts
(Mn: 4,300, Mw: 11,700, Tg: 55° C., manufactured by Kao Corporation) Carbon black (MA100, manufactured by Mitsubishi Chemical Corporation): 3 parts
Charge control agent (BONTRON E-84, manufactured by Orient Chemical Industries Co., Ltd.): 1 part
Mixture of carnauba wax and rice wax with a ratio of 60% to 40%: 4 parts

### Manufacturing of Mother Toner

The mixture of the prescription of toner is mixed and kneaded by an extruder, pulverized by a jet mill, and classified by an air classifier to obtain mother toner particles having an volume average particle diameter Dv of 4.62 μm, a ratio of Dv/Dn of the volume average particle diameter Dv to the number average particle diameter Dn of 1.20, a content ratio of the number of toner particles having a particle diameter of 4.0 μm or less of 58%, a content ratio of the number of toner particles having a particle diameter of 3.2 μm less of 34%, and a volume content ratio of toner particles having a particle diameter of 8.0 μm or greater of 1.8%.

### Mixing Process of External Additive

30 kg of the obtained classified mother toner is weighed and placed in the mixing room of a Henschel type super mixer (Henschel Mixer 20B, manufactured by NIPPON COKE & ENGINEERING. CO., LTD.). 0.1 kg of silica (RZD 972, manufactured by Tokuyama Corporation) having a specific surface area of 240 m2/g and 0.2 kg of titanium oxide (MT150AFM, manufactured by Tayca Corporation) are placed therein for mixing with a low energy first.

The temperature in the jacket at this point of time is controlled to be in the range of from 25° C. to 30° C.

The number of rotation of the stirring blade for the low energy mixing is 400 rpm and a cycle of a 60 second operation and a 10 second cooling down is repeated once.

Next, the mixture is subjected to mixing with a high energy.

The temperature in the jacket at this point of time is controlled to be in the range of from 30° C. to 34° C. The number of rotation of the stirring blade for the high energy mixing is 900 rpm and a cycle of a 90 second operation and a 30 second cooling down is repeated five times to obtain a black toner of Example 5.

The ratio and the amount of isolated silica in the obtained toner is measured in the same manner as in Example 1. The results are shown in Table 5.

### Example 6

The mixture obtained in Example 2 is mixed and kneaded by an extruder, pulverized by a jet mill, and classified by an air classifier to obtain mother toner particles having an volume average particle diameter Dv of 5.01 μm, a ratio of Dv/Dn of the volume average particle diameter Dv to the number average particle diameter Dn of 1.18, a content ratio of the number of toner particles having a particle diameter of 4.0 μm or less of 58.5%, a content ratio of the number of toner particles having a particle diameter of 3.2 μm or less of 34%, and a volume content ratio of toner particles having a particle diameter of 8.0 μm or greater of 1.8%.

30 kg of the obtained classified mother toner is weighed and placed in the mixing room of a Henschel type super mixer (Henschel Mixer 20B, manufactured by NIPPON COKE & ENGINEERING. CO., LTD.). 0.1 kg of silicae (RZD 972, manufactured by Tokuyama Corporation) having a specific surface area of 240 m2/g and 0.2 kg of titanium oxide (MT150AFM, manufactured by Tayca Corporation) are placed therein for mixing in the same manner as in Example 2 to obtain a black toner of Example 6.

### Example 7

### Prescription of Toner

Polyester resin (number average molecular weight Mn: 4,300 Weight average molecular weight Mw: 12,700, glass transition temperature Tg: 55° C.): 100 parts.
Carbon black (MA100, manufactured by Mitsubishi Chemical Corporation): 3 parts
Charge control agent (BONTRON E-84, manufactured by Orient Chemical Industries Co., Ltd.): 1 part
Mixture of carnauba wax and rice wax with a ratio of 60% to 40%: 4 parts

### Manufacturing of Mother Toner

The mixture of the prescription of toner is mixed and kneaded by an extruder, pulverized by a jet mill, and classified by an air classifier to obtain mother toner particles having an volume average particle diameter Dv of 4.85 μm, a ratio of Dv/Dn of the volume average particle diameter Dv to the number average particle diameter Dn of 1.13, a content ratio of the number of toner particles having a particle diameter of 4.0 μm or less of 61%, a content ratio of the number of toner particles having a particle diameter of 3.2 μm or less of 28.3%, and a volume content ratio of toner particles having a particle diameter of 8.0 μm or greater of 1.8%.

### Mixing Process of External Additive

30 kg of the obtained classified mother toner is weighed and placed in the mixing room of a Henschel type super mixer (Henschel Mixer 20B, manufactured by NIPPON COKE & ENGINEERING. CO., LTD.). 0.1 kg of silicon dioxide (RZD 970, manufactured by Tokuyama Corporation) having a specific surface area of 220 m2/g and 0.2 kg of titanium oxide (MT150AFM, manufactured by Tayca Corporation) are placed therein for mixing with a low energy first. The temperature in the first jacket at this point of time is controlled to be in the range of from 25° C. to 30° C.

The number of rotation of the stirring blade for the low energy mixing is 400 rpm and a cycle of a 60 second operation and a 10 second cooling down is repeated once.

Next, the mixture is subject to mixing with a high energy.

The temperature in the jacket at this point of time is controlled to be in the range of from 30° C. to 34° C. The number of rotation of the stirring blade for the high energy mixing is 900 rpm and a cycle of a 115 second operation and a 30 second cooling down is repeated five times to obtain a black toner of Example 7.

The amount and the ratio of isolated silica in the obtained toner are measured in the same manner as in Example 1.

The results are shown in Table 5.

### Example 8

### Prescription of Toner

Polyester resin (number average molecular weight Mn: 6,100; Weight average molecular weight Mw: 202,500; glass transition temperature Tg: 65° C.): 100 parts.
Yellow dye (C.I. Pigment Yellow 180): 3 parts
Charge control agent (BONTRON E-84, manufactured by Orient Chemical Industries Co., Ltd.): 1 part
Mixture of carnauba wax and rice wax with a ratio of 60% to 40%: 4 parts

### Manufacturing of Mother Toner

The mixture of the prescription of toner is mixed and kneaded by an extruder, pulverized by a jet mill, and classified by an air classifier to obtain mother toner particles having an volume average particle diameter Dv of 5.12 μm, a ratio of Dv/Dn of the volume average particle diameter Dv to the number average particle diameter Dn of 1.21, a content ratio of the number of toner particles having a particle diameter of 4.0 μm or less of 58%, a content ratio of the number of toner particles having a particle diameter of 3.2 μm or less of 32.3%, and a volume content ratio of toner particles having a particle diameter of 8.0 μm or greater of 1.8%.

### Mixing Process of External Additive

30 kg of the obtained classified mother toner is weighed and placed in the mixing room of a Henschel type super mixer (Henschel Mixer 20B, manufactured by NIPPON COKE & ENGINEERING. CO., LTD.). 0.1 kg of silicon dioxide (RZD 970, manufactured by Tokuyama Corporation) having a specific surface area of 220 m2/g and 0.3 kg of the surface-modified titanium oxide are placed therein for mixing with a low energy first.

The temperature in the jacket at this point of time is controlled to be in the range of from 25° C. to 30° C.

The number of rotation of the stirring blade for the low energy mixing is 400 rpm and a cycle of a 60 second operation and a 10 second cooling down is repeated once.

Next, the mixture is subjected to mixing with a high energy.

The temperature in the first jacket at this point of time is controlled to be in the range of from 20° C. to 30° C.

The number of rotation of the stirring blade for the high energy mixing is 800 rpm and a cycle of a 60 second operation and a 30 second cooling-down is repeated five times to obtain a yellow toner of Example 8.

The amount and the ratio of isolated silica in the obtained toner are measured in the same manner as in Example 1. The results are shown in Table 5.

### Example 9

30 Kg of the obtained classified mother toner is weighed and placed in the mixing room of a Henschel type super mixer (Henschel Mixer 20B, manufactured by NIPPON COKE & ENGINEERING. CO., LTD.). 0.15 kg of silicon dioxide (RZD 970, manufactured by Tokuyama Corporation) having a specific surface area of 220 m2/g and 0.3 kg of titanium oxide (MT150AFM, manufactured by Tayca Corporation) are placed therein for mixing with a low energy first.

The number of rotation of the stirring blade for the low energy mixing is 400 rpm and a cycle of a 60 second operation and a 10 second cooling-down is repeated once. Thereafter, the mixture is mixed at a high speed in a Henschel type super mixer (Henschel Mixer 20B, manufactured by NIPPON COKE & ENGINEERING. CO., LTD.) and the temperature in the jacket at this point of time is controlled to be in the range of from 20° C. to 30° C. The number of rotation of the stirring blade is 800 rpm and a cycle of a 60 second operation and a 40 second cooling down is repeated seven times to obtain a black toner of Example 9.

The amount and the ratio of isolated silica in the obtained toner are measured in the same manner as in Example 1. The results are shown in Table 5.

### Comparative Example 1

Next, Comparative Examples are described.

The mixture of the prescription of toner having the same prescription as Example 1 is mixed and kneaded by an extruder, pulverized by a jet mill, and classified by an air classifier to obtain mother toner particles having an volume average particle diameter Dv of 5.12 μm, a ratio of Dv/Dn of the volume average particle diameter Dv to the number average particle diameter Dn of 1.45, a content ratio of the number of toner particles having a particle diameter of 4.0 μm or less of 68%, a content ratio of the number of toner particles having a particle diameter of 3.2 μm or less of 40.3%, and a volume content ratio of toner particles having a particle diameter of 8.0 μm or greater of 2.5%.

30 kg of the obtained classified mother toner particles is weighed and placed in the mixing room of a Henschel type super mixer (Henschel Mixer 20B, manufactured by NIPPON COKE & ENGINEERING. CO., LTD.). 0.2 kg of silica (R 972, manufactured by Nippon Aerosil Co., Ltd.) and 0.2 kg of titanium oxide (MT150AFM, manufactured by Tayca Corporation) are placed therein for mixing at a high speed.

The temperature in the jacket at this point of time is controlled to be in the range of from 35° C. to 40° C.

The number of rotation of the stirring blade for the high speed mixing is 800 rpm and a cycle of a 10 second operation and a 30 second cooling down is repeated three times to obtain a black toner of Comparative Example 1.

The amount and the ratio of isolated silica in the obtained toner are measured in the same manner as in Example 1.

The results are shown in Table 5.

### Comparative Example 2

The mixture of the prescription of toner having the same prescription of Example 1 is mixed and kneaded by an extruder, pulverized by a jet mill, and classified by an air classifier to obtain mother toner particles having an volume average particle diameter Dv of 5.51 μm, a ratio of Dv/Dn of the volume average particle diameter Dv to the number average particle diameter Dn of 1.45, a content ratio of the number of toner particles having a particle diameter of 4.0 μm or less of 58%, a content ratio of the number of toner particles having a particle diameter of 3.2 μm or less of 35.3%, and a volume content ratio of toner particles having a particle diameter of 8.0 μm or greater of 2.8%.

30 kg of the obtained classified mother toner is weighed and placed in the mixing room of a Henschel type super mixer (Henschel Mixer 20B, manufactured by NIPPON COKE & ENGINEERING. CO., LTD.). 0.2 kg of silica (R 972, manufactured by Nippon Aerosil Co., Ltd.) and 0.3 kg of titanium oxide (MT150AFM, manufactured by Tayca Corporation) are placed therein for mixing at a high speed.

The temperature in the jacket at this point of time is controlled to be in the range of from 35° C. to 40° C.

The number of rotation of the stirring blade for the high speed mixing is 800 rpm and a cycle of a 35 second operation and a 5 second cooling-down is repeated three times to obtain a black toner of Comparative Example 2.

The amount and the ratio of isolated silica in the obtained toner are measured in the same manner as in Example 1. The results are shown in Table 5.

### Comparative Example 3

The mixture of the prescription of toner having the same prescription of Example 1 is mixed and kneaded by an extruder, pulverized by a jet mill, and classified by an air classifier to obtain mother toner particles having an volume average particle diameter Dv of 6.12 μm, a ratio of Dv/Dn of the volume average particle diameter Dv to the number average particle diameter Dn of 1.41, a content ratio of the number of toner particles having a particle diameter of 4.0 μm or less of 68%, a content ratio of the number of toner particles having a particle diameter of 3.2 μm or less of 36.3%, and a volume content ratio of toner particles having a particle diameter of 8.0 μm or greater of 2.5%.

30 kg of the obtained classified mother toner is weighed and placed in the mixing room of a Henschel type super mixer (Henschel Mixer 20B, manufactured by NIPPON COKE & ENGINEERING. CO., LTD.). 0.2 kg of silica (R 972, manufactured by Nippon Aerosil Co., Ltd.) and 0.3 kg of titanium oxide (MT150AFM, manufactured by Tayca Corporation) are placed therein for mixing at a high speed.

The temperature in the jacket at this point of time is controlled to be in the range of from 35° C. to 40° C.

The number of rotation of the stirring blade for the high speed mixing is 800 rpm and a cycle of a 40 second operation and a 5 second cooling down is repeated twice to obtain a black toner of Comparative Example 3.

The ratio and the amount of isolated silica in the obtained toner is measured in the same manner as in Example 1. The results are shown in Table 5.

### Comparative Example 4

The mixture of the prescription of toner having the same prescription of Example 1 is mixed and kneaded by an extruder, pulverized by a jet mill, and classified by an air classifier to obtain mother toner particles having an volume average particle diameter Dv of 6.3 μm, a ratio of Dv/Dn of the volume average particle diameter Dv to the number average particle diameter Dn of 1.45, a content ratio of the number of toner particles having a particle diameter of 4.0 μm or less of 68%, a content ratio of the number of toner particles having a particle diameter of 3.2 μm or less of 37.3%, and a volume content ratio of toner particle's having a particle diameter of 8.0 μm or greater of 2.8%.

30 kg of the obtained classified mother toner is weighed and placed in the mixing room of a Henschel type super mixer (Henschel Mixer 20B, manufactured by NIPPON COKE & ENGINEERING. CO., LTD.). 0.2 kg of silica (R 972, manufactured by Nippon Aerosil Co., Ltd.) and 0.2 kg of titanium oxide (MT150AFM, manufactured by Tayca Corporation) are placed therein for mixing at a high speed.

A toner of Comparative Example 4 is manufactured in the same manner as in Comparative Example 3.

The amount and the ratio of isolated silica in the obtained toner are measured in the same manner as in Example 1.

The results are shown in Table 5.

### Comparative Example 5

The mixture of the prescription of toner having the same prescription of Example 2 is mixed and kneaded by an extruder, pulverized by a jet mill, and classified by an air classifier to obtain mother toner particles having an volume average particle diameter Dv of 6.12 μm, a ratio of Dv/Dn of the volume average particle diameter Dv to the number average particle diameter Dn of 1.51, a content ratio of the number of toner particles having a particle diameter of 4.0 μm or less of 78%, a content ratio of the number of toner particles having a particle diameter of 3.2 μm or less of 35.3%, and a volume content ratio of toner particles having a particle diameter of 8.0 μm or greater of 3.8%.

30 kg of the obtained classified mother toner is weighed and placed in the mixing room of a Henschel type super mixer (Henschel Mixer 20B, manufactured by NIPPON COKE & ENGINEERING. CO., LTD.). 0.2 kg of silica (R 972, manufactured by Nippon Aerosil Co., Ltd.) and 0.3 kg of titanium oxide (MT150AFM, manufactured by Tayca Corporation) are placed therein for mixing at a high speed.

The temperature in the first jacket at this point of time is controlled to be in the range of from 35° C. to 40° C.

The number of rotation of the stirring blade for the high speed mixing is 1,200 rpm and a cycle of a 50 second operation and a 10 second cooling down is repeated twice to obtain a black toner of Comparative Example 5.

The ratio and the amount of isolated silica in the obtained toner are measured in the same manner as in Example 1. The results are shown in Table 5.

### Comparative Example 6

The mixture of the prescription of toner having the same prescription of Example 5 is mixed and kneaded by an extruder, pulverized by a jet mill, and classified by an air classifier to obtain mother toner particles having an volume average particle diameter Dv of 5.80 μm, a ratio of Dv/Dn of the volume average particle diameter Dv to the number average particle diameter Dn of 1.55, a content ratio of the number of toner particles having a particle diameter of 4.0 μm or less of 78%, a content ratio of the number of toner particles having a particle diameter of 3.2 μm or less of 35.3%, and a volume content ratio of toner particles having a particle diameter of 8.0 μm or greater of 3.8%. 30 kg of the obtained classified mother toner is weighed and placed in the mixing room of a Henschel type super mixer (Henschel Mixer 20B, manufactured by NIPPON COKE & ENGINEERING. CO., LTD.). 0.2 kg of silica (R 972, manufactured by Nippon Aerosil Co., Ltd.) and 0.3 kg of titanium oxide (MT150AFM, manufactured by Tayca Corporation) are placed therein for mixing at a high speed.

The temperature in the jacket at this point of time is controlled to be in the range of from 35° C. to 40° C.

The number of rotation of the stirring blade for the high speed mixing is 1,200 rpm and a cycle of a 56 second operation and a seven second cooling down is repeated five times to obtain a black toner of Comparative Example 6.

The ratio and the amount of isolated silica in the obtained toner are measured in the same manner as in Example 1. The results are shown in Table 5.

### Comparative Example 7

### Prescription of Toner

Polyester resin (number average molecular weight Mn: 4,300 Weight average molecular weight Mw: 12,700, glass transition temperature Tg: 55° C.): 100 parts.
Carbon black (MA100, manufactured by Mitsubishi Chemical Corporation): 3 parts
Charge control agent (BONTRON E-84, manufactured by Orient Chemical Industries Co., Ltd.): 1 part
Carnauba wax: 3 parts

### Manufacturing of Toner

The mixture of the prescription of toner is mixed and kneaded by an extruder, pulverized by a jet mill, and classified by an air classifier to obtain mother toner particles having an volume average particle diameter Dv of 5.32 μm, a ratio of Dv/Dn of the volume average particle diameter Dv to the number average particle diameter Dn of 1.81, a content ratio of the number of toner particles having a particle diameter of 4.0 μm or less of 58%, a content ratio of the number of toner particles having a particle diameter of 3.2 μm or less of 35.3%, and a volume content ratio of toner particles having a particle diameter of 8.0 μm or greater of 2.8%.

### Mixing Process of External Additive

30 kg of the obtained mother toner is weighed and placed in the mixing room of a Henschel type super mixer (Henschel Mixer 20B, manufactured by NIPPON COKE & ENGINEERING. CO., LTD.). 0.5 kg of silica specified in JP-2006-154387-A (HDK, H1303, manufactured by Clariant Japan) and 0.3 kg of titanium oxide (MT150AFM, manufactured by Tayca Corporation) are placed therein for mixing at a high speed.

The temperature in the jacket at this point of time is not controlled particularly.

The number of rotation of the stirring blade is 2,500 rpm and the mixing time is three minutes followed by screening with a sieve having an opening of 3 μm. Thus, a black toner of Comparative Example 7 is obtained.

The ratio and the amount of isolated silica in the obtained toner are measured in the same manner as in Example 1. The results are shown in Table 5.

### Image Evaluation

The toners obtained in Examples and Comparative Examples are set in a digital color printer (IPSIO Color 8500, manufactured by Ricoh Co. Ltd.) and output images are evaluated in the LL and the HH environment.

Evaluation is made after a run length of 10,000 sheets of an image chart having a 7% image ratio for each following evaluation item.

The initial image density represents the image density after a run length of 10,000 sheets.

LL environment represents 10° C. and 15% RH and HH environment represents 30° C. and 80% RH.

### Image Density

After outputting a solid image on a sheet (6000, manufactured by Ricoh Co., Ltd.), the initial image density and the image density after 30,000 outputs are measured by (X-Rite, manufactured by X-Rite Co., Ltd.) and evaluated according to the following criteria.

### Evaluation Criteria

B (Bad): Image density of from 1.0 to less than 1.4

G (Good): Image density of from 1.4 to less than 1.8

E (Excellent): Image density of from 1.8 to less than 2.2

### Abnormal Image (Filming)

Occurrence of white spot is evaluated for the solid image produced after 10,000 outputs and 30,000 outputs. Occurrence of the white spot is determined by observation of naked eyes.

### Evaluation Criteria

E (Excellent): No white spot for 100 sampling sheets

G (Good): White spot occurs in the ratio of from 2% to less than 10%

F (Fair): White spot occurs in the ratio of from 10% to less than 20%

B (Bad): White spot occurs in the ratio of 20% or greater

### Amount of Charge

The amount of charge of the toner on the development roller of the digital color printer is measured according to the absorption method.

### Fine Line Reproducibility

Fine line images of 600 dpi after 30,000 outputs are output on paper (6000, manufactured by Ricoh Co., Ltd.) and the degree of blurring of the fine line is evaluated with the samples.

### Background Fouling

After 30,000 outputs, printing a white image is stopped in the middle of development and the development agent on the image bearing member after development is transferred to a tape. The difference of the image density between the tape and a non-transferred tape is measured by 938 specrtrodensitometer (manufactured by X-Rite Co., Ltd.) and evaluated as E (Excellent), G (Good), F (Fair), and B (bad).

The smaller the image density difference, the better the background fouling.

TABLE 4

| | | | Amount of fine |
|---|---|---|---|
| | | | powder having a |
| | Volume average | | particle |
| | particle | | diameter of 3.2 |
| | diameter (μm) | Dv/Dn | μm (%) |
| Example 1 | 4.90 | 1.15 | 32.0 |
| Example 2 | 4.90 | 1.15 | 32.0 |
| Example 3 | 4.90 | 1.15 | 32.0 |
| Example 4 | 4.71 | 1.24 | 33.0 |
| Example 5 | 4.62 | 1.20 | 34.0 |
| Example 6 | 5.01 | 1.18 | 34.0 |
| Example 7 | 4.85 | 1.13 | 28.3 |
| Example 8 | 5.12 | 1.21 | 32.3 |
| Example 9 | 4.90 | 1.15 | 32.0 |
| Comparative | 5.12 | 1.45 | 40.3 |
| Example 1 | | | |
| Comparative | 5.51 | 1.45 | 35.3 |
| Example 2 | | | |
| Comparative | 6.12 | 1.41 | 36.3 |
| Example 3 | | | |
| Comparative | 6.30 | 1.45 | 37.3 |
| Example 4 | | | |
| Comparative | 6.12 | 1.51 | 35.3 |
| Example 5 | | | |
| Comparative | 5.80 | 1.55 | 35.3 |
| Example 6 | | | |
| Comparative | 5.32 | 1.81 | 35.3 |
| Example 7 | | | |

TABLE 5

| | Item | | | | |
|---|---|---|---|---|---|
| | Mixing Condition of External | | | | |
| | Additive | | | | |
| | Ratio (Mixing time to Cooling- | | | Silica | |
| Examples and | down time) | | | Isolation | Isolated |
| Comparative | Temperature | | Number of | ratio | amount |
| Examples | range (° C.) | Ratio | times | (%) | (ppm) |
| Example 1 | 25-30 | 6.0 | 10 (1 + 9) | 0.28 | 1.02 |
| Example 2 | 25-30 | 3.0 | 10 (1 + 9) | 0.58 | 2.02 |
| Example 3 | 25-30 | 3.0 | 10 (1 + 9) | 0.50 | 1.81 |
| Example 4 | 25-30 | 1.8 | 8 (1 + 7) | 0.84 | 3.04 |
| Example 5 | 30-34 | 3.0 | 6 (1 + 5) | 0.63 | 2.28 |
| Example 6 | 30-34 | 3.0 | 6 (1 + 5) | 0.80 | 2.86 |
| Example 7 | 30-34 | 3.8 | 6 (1 + 5) | 0.30 | 1.45 |
| Example 8 | 20-30 | 2.0 | 6 (1 + 5) | 0.34 | 1.23 |
| Example 9 | 20-30 | 1.5 | 8 (1 + 7) | 0.35 | 1.27 |
| Comparative | 35-40 | 0.3 | 3 (0 + 3) | 11.19 | 40.31 |
| Example 1 | | | | | |
| Comparative | 35-40 | 7 | 3 (0 + 3) | 11.86 | 42.67 |
| Example 2 | | | | | |
| Comparative | 35-40 | 8 | 2 (0 + 2) | 11.51 | 41.45 |
| Example 3 | | | | | |
| Comparative | 35-40 | 8 | 2 (0 + 2) | 15.37 | 55.34 |
| Example 4 | | | | | |
| Comparative | 35-40 | 5 | 2 (0 + 2) | 14.51 | 52.25 |
| Example 5 | | | | | |
| Comparative | 35-40 | 8 | 5 (0 + 5) | 11.84 | 41.46 |
| Example 6 | | | | | |
| Comparative | None | — | 0 | 9.49 | 30.57 |
| Example 7 | | | | | |

| | Item | | | |
|---|---|---|---|---|
| | Titanium | | Toner Property | |
| Examples and | Isolation | Isolated | Charging property (μC/g) | |
| Comparative | ratio | amount | LL en- | HH en- |
| Examples | (%) | (ppm) | vironment | vironment |
| Example 1 | 0.38 | 1.03 | −33.5 | −27.3 |
| Example 2 | 0.28 | 0.76 | −33.7 | −29.2 |
| Example 3 | 0.35 | 0.95 | −34.5 | −28.1 |
| Example 4 | 0.58 | 1.56 | −34.1 | −27.6 |
| Example 5 | 0.36 | 0.98 | −34.5 | −27.5 |
| Example 6 | 0.48 | 1.26 | −34.5 | −26.8 |
| Example 7 | 0.22 | 0.73 | −34.8 | −27.3 |
| Example 8 | 0.50 | 1.34 | −34.5 | −27.1 |
| Example 9 | 0.35 | 1.87 | −34.5 | −27.3 |
| Comparative | 5.64 | 15.25 | −30.7 | −16.5 |
| Example 1 | | | | |
| Comparative | 6.07 | 16.38 | −32.8 | −19.2 |
| Example 2 | | | | |
| Comparative | 6.0 | 16.20 | −32.3 | −18.2 |
| Example 3 | | | | |
| Comparative | 7.60 | 20.51 | −30.7 | −17.8 |
| Example 4 | | | | |
| Comparative | 7.41 | 20.02 | −32.8 | −18.9 |
| Example 5 | | | | |
| Comparative | 6.93 | 18.72 | −30.9 | −16.5 |
| Example 6 | | | | |
| Comparative | 7.41 | 20.00 | −29.8 | −18.2 |
| Example 7 | | | | |

| | Image density | | | | |
|---|---|---|---|---|---|
| | Initial image | | After 30,000 outputs | | Fine line |
| | LL en- | HH en- | LL en- | HH en- | repro- |
| | vironment | vironment | vironment | vironment | ducebility |
| Example 1 | E | E | E | E | E |
| Example 2 | E | E | E | E | E |
| Example 3 | E | E | E | E | E |
| Example 4 | E | E | E | E | E |
| Example 5 | E | E | E | E | E |
| Example 6 | E | E | E | E | E |
| Example 7 | E | E | E | E | E |
| Example 8 | E | E | E | E | E |
| Example 9 | E | E | E | E | E |
| Comparative | G | F | G | F | B |
| Example 1 | | | | | |
| Comparative | G | G | G | F | B |
| Example 2 | | | | | |
| Comparative | G | F | B | B | B |
| Example 3 | | | | | |
| Comparative | G | F | G | B | B |
| Example 4 | | | | | |
| Comparative | G | F | G | B | B |
| Example 5 | | | | | |
| Comparative | G | F | G | B | B |
| Example 6 | | | | | |
| Comparative | G | F | F | B | B |
| Example 7 | | | | | |

| | | Abnormal Image (Filming) | | | |
|---|---|---|---|---|---|
| | Back- | Initial image | | After 30,000 outputs | |
| | ground | HH en- | LL en- | HH en- | LL en- |
| | fouling | vironment | vironment | vironment | vironment |
| Example 1 | E | E | E | E | E |
| Example 2 | E | E | E | E | E |
| Example 3 | E | E | E | E | E |
| Example 4 | E | E | E | E | E |
| Example 5 | E | E | E | E | E |
| Example 6 | E | E | E | E | E |
| Example 7 | E | E | E | E | E |
| Example 8 | E | E | E | E | E |
| Example 9 | E | E | E | E | E |
| Comparative | B | G | F | B | F |
| Example 1 | | | | | |
| Comparative | B | G | G | B | F |
| Example 2 | | | | | |
| Comparative | B | B | B | B | B |
| Example 3 | | | | | |
| Comparative | B | G | B | B | B |
| Example 4 | | | | | |
| Comparative | B | G | B | B | B |
| Example 5 | | | | | |
| Comparative | B | G | B | B | B |
| Example 6 | | | | | |
| Comparative | B | G | B | B | B |
| Example 7 | | | | | |

This document claims priority and contains subject matter related to Japanese Patent Applications nos. 2010-061713, 2010-061711, 2010-169355, and 2010-169224, filed on Mar. 17, 2010, Mar. 17 2010, Jul. 28, 2010, and Jul. 28, 2010, respectively, the entire contents of which are hereby incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a mother toner particle comprising a binder resin, a releasing agent, and a coloring agent; and
an external additive comprising an inorganic particulate, which is mixed with the mother toner particle in a mixing process by a mixer,
wherein the external additive is isolated from the mother toner particle by ultrasonic vibration and collected, in an aqueous solution comprising a polyoxyethylene lauryl ether compound serving as a surface active agent, in an amount of from 0.1 ppm to 10 ppm/(toner 4 g/100 ml) as measured by atomic absorption spectrometry.

2. The toner according to claim 1, wherein the mixing process comprises one or more cycles comprising operation time and cooling-down time in a ratio of from 0.5 to 5.0 of the operation time to the cooling-down time.

3. The toner according to claim 2, wherein one cycle of operation time and cooling-down time is from one minute to two minutes.

4. The toner according to claim 1, wherein the mixing process comprises dispersing the inorganic particulate in the mother toner particle and attaching the inorganic particulate to the mother toner particle.

5. The toner according to claim 1, wherein:
the inorganic particulates comprises silica; and
an isolated amount of silica from the mother toner particle as measured by atomic absorption spectrometry is from 0.1 ppm to 10 ppm/(toner 4 g/100 ml).

6. The toner according to claim 5, wherein the silica has a specific surface area of from 150 m²/g to 250 m²/g.

7. The toner according to claim 6, wherein:
the inorganic particulate comprise titanium oxide; and
an amount of titanium in isolated titanium oxide from the mother toner particle measured by atomic absorption spectrometry is from 0.1 ppm to 5 ppm/(toner 4 g/100 ml).

8. The toner according to claim 7, wherein the silica is attached to a surface of the mother toner particle together with or prior to the titanium oxide.

9. The toner according to claim 1, wherein the mother toner particle has a volume average particle diameter Dv of from 4.5 to 5.2 μm, a content ratio of particles having a particle diameter of 4.0 μm or less of 60% or less by quantity, and a ratio (Dv/Dn) of the volume average particle diameter Dv to a number average particle diameter Dn of from 1.10 to 1.40.

10. The toner according to claim 1, wherein the mother toner particle has a content ratio of particles having a particle diameter of 3.2 μm or less of 35% or less by quantity and a volume content ratio of particles having a particle diameter of 8 μm or greater of 2.0% or less.

11. The toner according to claim 1, wherein a content of the releasing agent in the mother toner particle is less than 6% by weight.

12. The toner according to claim 1, further comprising a charge control agent.

13. The toner according to claim 1, wherein the binder resin comprises a polyester resin.

14. A method of manufacturing toner, comprising the steps of:
pulverizing a toner material comprising a binder resin, a releasing agent, and a coloring agent to obtain pulverized toner material;
air-classifying the pulverized toner material to obtain a mother toner particle; and
mixing an external additive comprising an inorganic particulate with the mother toner particle using a mixer, comprising the steps of dispersing the inorganic particulate to the mother toner particle and attaching the inorganic particulate to the mother toner particle,
wherein the external additive is isolated from the mother toner particle by ultrasonic vibration and collected, in an aqueous solution comprising a polyoxyethylene lauryl ether compound serving as a surface active agent, in an amount of from 0.1 ppm to 10 ppm/(toner 4 g/100 ml) as measured by atomic absorption spectrometry.

15. The method of manufacturing toner according to claim 14, wherein the step of mixing comprises an operation time and a cooling-down time with a ratio of the operation time to the cooling-down time mixing time of from 0.5 to 5.0.

16. The method of manufacturing toner according to claim 15, wherein the mixer has a stirring blade and one cycle of the operation time and the cooling-down time is from one minute to two minute.

17. An image forming method comprising:
forming a latent electrostatic image on an image bearing member;
developing the latent electrostatic image with the toner of claim 1 to obtain a toner image;
transferring the toner image to a recording medium; and
fixing the toner image on the recording medium.
